(19) United States
(12) Patent Application Publication
(10) Pub. No.: US 2024/0198458 A1
(43) Pub. Date: Jun. 20, 2024

(54) LASER CUT GLASS SHEETS FOR ELECTRICALLY CONTROLLABLE OPTICALLY ACTIVE STRUCTURES

(71) Applicant: Cardinal IG Company, Eden Prairie, MN (US)

(72) Inventors: Andrew DeMiglio, Savage, MN (US); Nathan Kintzi, Minneapolis, MN (US); Hannes Bassen, Alsdorf (DE); Anas Moalem, Eschweiler (DE)

(21) Appl. No.: 18/542,442

(22) Filed: Dec. 15, 2023

Related U.S. Application Data
(60) Provisional application No. 63/387,729, filed on Dec. 16, 2022.

(51) Int. Cl. B23K 26/53; B23K 26/40; B23K 26/55; B23K 26/57

(52) U.S. Cl. CPC B23K 26/53; B23K 26/40; B23K 26/55; B23K 26/57; B23K 2103/54

(57) ABSTRACT

A multilayer glass panel may be cut using a laser cutting technique. In some examples, the technique involves directing a laser beam into to panel to form a separation line. The separation line includes a plurality of spaced-apart defect columns extending at least partially through a first glass substrate but not through a second glass substrate. The plurality of spaced-apart defect columns each include a plurality of spaced-apart filamentation flaws. The example method can also involve separating a portion of the first glass substrate from the second glass substrate along the separation line to thereby configure the multilayer panel with a shelf defined by a portion of the second glass substrate extending outwardly from the separation line.

### CROSS REFERENCE

This application claims the benefit of U.S. Provisional Patent Application No. 63/387,729, filed Dec. 16, 2022, the entire contents of which are incorporated herein by reference.

### TECHNICAL FIELD

This disclosure relates to laser cutting of glass substrates and electrically controllable optically active structures incorporating laser cut glass substrates.

### BACKGROUND

Windows, doors, partitions, and other structures having controllable light modulation have been gaining popularity in the marketplace. These structures are commonly referred to as “smart” structures or “privacy” structures for their ability to transform from a transparent state in which a user can see through the structure to a private state in which viewing is inhibited through the structure. For example, smart windows are being used in high-end automobiles and homes and smart partitions are being used as walls in office spaces to provide controlled privacy and visual darkening.

A variety of different technologies can be used to provide controlled optical transmission for a smart structure. For example, electrochromic technologies, photochromic technologies, thermochromic technologies, suspended particle technologies, and liquid crystal technologies are all being used in different smart structure applications to provide controllable privacy. The technologies generally use an energy source, such as electricity, to transform from a transparent state to a privacy state or vice versa.

To fabricate a privacy structure, a controllable privacy material can be interposed between two transparent substrates, such as two glass substrates. The glass substrates can be cut from a larger mother sheet of glass to have the size and shape required for the particular privacy structure being fabricated. Glass substrates can be cut using mechanical scoring and breaking systems or using laser cutting systems.

### SUMMARY

In general, this disclosure is directed to systems and techniques for laser cutting of glass substrates and associated laser cut glass substrates and articles incorporating such substrates. In some examples, the described laser cutting techniques are implemented to cut a multilayer glass panel that includes a first glass substrate joined to a second glass substrate. To cut the multilayer glass panel, a laser beam may be directed into the multilayer glass panel to form a separation line where one region of glass is intended to be separated from another region of glass during the cutting process. The separation line may be formed to facilitate removal of a portion of one of the two glass substrates from a remaining portion of that glass substrate without cutting the second glass substrate underlying the separation line. For example, when starting with a multilayer glass panel that includes two overlapping substrates joined together, the laser beam can be directed into one of the two glass substrates to form the separation line along that glass substrate without perforating the underlying glass substrate. A portion of the first glass substrate can then be broken away from a remainder of that glass substrate without laser cutting or breaking away a corresponding portion of the second substrate overlapping with and/or underlying the portion of the first glass substrate removed through the laser cutting process.

In some implementations, one or both glass substrates of the multilayer glass panel carry an electrode layer, such as a transparent conductive oxide coating deposited over the surface of the substrate. The multilayer glass panel may include two glass substrates each having an electrode layer facing the other glass substrate with an electrically controllable optically active material positioned between the two glass substrates. In such implementations, a laser cutting technique may be utilized to remove a portion of one of the glass substrates to expose an underlying region of the other glass substrate. This can create an exposed shelf to which an electrode can be connected to supply power to the electrode layer on that exposed shelf and, correspondingly, to the optically active material positioned between the two glass substrates.

In practice, when using a laser to cut through the first glass substrate of the multilayer glass panel, the laser may have a tendency to damage the electrode layer on the underlying second glass substrate. For example, the laser may ablate the electrode layer on the underlying second glass substrate as the laser is passed across the first glass substrate to form the separation line. When subsequently connecting an electrode to electrode layer on the second glass substrate, electrical transmission from the electrode to the electrode layer, and correspondingly to the electrically conductive optically active material, may be inhibited because of the damage to the electrode layer caused when laser cutting the first glass substrate.

In accordance with some examples of the present disclosure, however, a multilayer glass panel may be laser cut while maintaining sufficient electrical conductivity of the electrode layer underlying the glass panel substrate being cut. For example, a laser cutting technique may be utilized to remove a portion of a first glass substrate while ensuring that the electrode layer on the underlying second glass substrate is sufficiently undamaged from the laser cutting process such that the electrode layer can transmit electricity to power to the electrically controllable optically active material sandwiched between the two glass substrates.

In some examples, a cutting technique involves directing a laser beam into the multilayer panel to form a separation line extending at least partially through a first glass substrate of the panel but not through a second glass substrate of the panel. The laser beam can be used to form multiple spaced-apart defect columns extending at least partially through the first glass substrate but not through the second glass substrate. Each defect column can be formed from multiple spaced-apart filamentation flaws. Accordingly, in such implementations, the first glass substrate can be filamented using the laser with groups of filaments forming defect columns. Regions of the multilayer glass panel between adjacent defect columns may be devoid of laser defects. When so implemented, the electrode layer on the second glass substrate underlying the first glass substrate being laser cut may be damaged below the defect columns but may remain undamaged between defect columns. As a result, the electrode layer on the second glass substrate may maintain sufficient electrical conductivity (e.g., via undamaged regions between damaged regions underlying the defect columns formed into the first glass substrate) to provide electrical conductivity to and control of the electrically controllable optically active material sandwiched between the two glass substrates.

In some implementations, one or more subsequent laser treatment steps may be performed on the multilayer glass panel after initially forming the laser separation line. For example, one or more laser beams may be directed across the separation line initially formed on the multilayer glass panel to form multiple secondary spaced-apart filamentation flaws. The secondary spaced-apart filamentation flaws may be overlapped with and/or interleaved between the spaced-apart defect columns and/or spaced-apart filamentations in each defect column. In some examples, secondary spaced-apart filamentation flaws extend partially but not fully through a thickness of the first glass substrate forming the multilayer glass panel. For example, the secondary spaced-apart filamentation flaws extend a distance through the thickness of the first glass substrate less than a distance the spaced-apart defect columns extend through the thickness of the first glass substrate. The secondary spaced-apart filamentation flaws may or may not be substantially continuously formed across the length of the separation line. In some examples, the secondary spaced-apart filamentation flaws define a laser-cut cap overlaying the separation line defined by the spaced-apart defect columns. The secondary spaced-apart filamentation flaws may case breakout of one portion of the first glass substrate relative to another portion of the substrate along the separation line.

In one example, a method of laser cutting a multilayer glass panel is described. The method includes directing a laser beam into a multilayer panel that includes a first glass substrate joined to a second glass substrate. The example specifies that directing the laser beam into the multilayer panel includes forming a separation line comprising a plurality of spaced-apart defect columns extending at least partially through the first glass substrate but not through the second glass substrate, each of the plurality of spaced-apart defect columns comprising a plurality of spaced-apart filamentation flaws. The method also includes separating a portion of the first glass substrate from the second glass substrate along the separation line to thereby configure the multilayer panel with a shelf defined by a portion of the second glass substrate extending outwardly from the separation line.

In another example, an electrically controllable optically active structure is described that a first glass substrate, a second glass substrate, an electrically controllable optically active material, a first electrically conductive layer, and a second electrically conductive layer. The example specifies that the first glass substrate has an inner face and an outer face, the second glass substrate has an inner face and an outer face, and the second glass substrate is joined to the first glass substrate with the inner face of the first glass substrate facing the inner face of the second glass substrate. The example also states that the electrically controllable optically active material is positioned between the inner face of the first glass substrate and the inner face of the second glass substrate. The first electrically conductive layer is carried by the inner face of the first glass substrate and the second electrically conductive layer carried by the inner face of the second glass substrate. The first electrically conductive layer and the second electrically conductive layer are arranged to electrically control the electrically controllable optically active material. According to the example, the first glass substrate, the second glass substrate, and the electrically controllable optically active material define a multilayer panel having a first side edge and a second side edge. The first side edge defines a first shelf that includes a portion of the second glass substrate extending outwardly from a cut edge of the first glass substrate. The cut edge of the first glass substrate has a plurality of spaced-apart defect columns extending at least partially through the first glass substrate but not through the second glass substrate, each of the plurality of spaced-apart defect columns comprising a plurality of spaced-apart filamentation flaws. The second side edge defines a second shelf that includes a portion of the first glass substrate extending outwardly from a cut edge of the second glass substrate. The cut edge of the second glass substrate has a plurality of spaced-apart defect columns extending at least partially through the second glass substrate but not through the second glass substrate, each of the plurality of spaced-apart defect columns comprising a plurality of spaced-apart filamentation flaws.

In another example, a method is described that involves directing a laser beam into a mother sheet that includes a first glass substrate joined to a second glass substrate with a plurality of defined zones each including an electrically controllable optically active material between the first glass substrate and the second glass substrate. The example specifies that directing the laser beam into the mother sheet includes forming a separation line to separate at least one of the plurality of defined zones from an adjacent region of the mother sheet, and where forming the separation line includes forming a plurality of spaced-apart defect columns extending at least partially through the first glass substrate but not through the second glass substrate, each of the plurality of spaced-apart defect columns comprising a plurality of spaced-apart filamentation flaws. The method also includes separating one of the plurality of defined zones including the electrically controllable optically active material from the adjacent region of the mother sheet by at least separating a portion of the first glass substrate from the second glass substrate along the separation line to thereby configure the separated one of the plurality of defined zones with a shelf comprising by a portion of the second glass substrate extending outwardly from the separation line.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a side view of an example multilayer glass panel that maybe laser cut according to the disclosure.

FIG. 2 is a flow chart of an example technique for laser cutting a multilayer panel.

FIG. 3 is a side sectional view of the example multilayer panel of FIG. 1 illustrating a laser beam being directed from a laser into multilayer glass panel.

FIG. 4 is an enlarged side view of an example defect column from FIG. 3.

FIG. 5 is a side sectional view of the example multilayer panel of FIG. 3 illustrating a secondary laser beam being directed from a secondary laser into the multilayer glass panel.

FIG. 6A is a perspective view of an example configuration of a multilayer panel after a portion of a first substrate has been separated from a remaining portion to provide a shelf.

FIG. 6B is a side view of an example configuration of a multilayer panel that is partially cut along its length with a continuous series of filamentation flaws and partially cut along its length with filamentation flaws grouped into defect columns.

FIGS. 7A and 7B are top views of example configurations of first and second substrates that can be used to form a mother sheet.

FIG. 8 is a top view of an example mother sheet formed by overlaying and joining the substrates of FIGS. 7A and 7B.

FIG. 9 is a side view of an example privacy glazing structure that can incorporate a laser-cut multilayer panel according to the disclosure.

FIG. 10 is an exploded perspective view of an example configuration of the example privacy glazing structure of FIG. 9.

FIG. 11 is a side view of the example privacy glazing structure of FIG. 9 from the perspective of the fourth substrate.

FIG. 12 is a first side view of the example privacy glazing structure of FIG. 9 taken along the B-B sectional line indicated on FIG. 11.

FIG. 13 is a second side view of the example privacy glazing structure of FIG. 9 taken along the C-C sectional line indicated on FIG. 11.

FIG. 14 is a perspective view of an example electrode that can be used on a privacy glazing structure.

### DETAILED DESCRIPTION

The present disclosure is generally directed to systems and techniques for laser cutting of glass substrates and associated laser cut glass substrates and articles incorporating such substrates. In some examples, a laser cut substrate according to the disclosure is utilized as part of a privacy structure. The privacy structure may be an optical structure that includes an electrically controllable optically active material that provides controlled transition between a privacy or scattering state and a visible or transmittance state. To make electrical connections with electrode layers that control the optically active material, the optical structure may include electrode engagement regions. In some examples, the electrode engagement regions are formed by offsetting panes carrying the electrode layers relative to each other and/or relative to outer sandwiching panes. This can provide lateral recesses exposing electrode engagement regions of the electrode layer to which one or more electrodes can be physically and/or electrically coupled.

To form the electrode engagement regions, a multilayer glass panel may be laser cut. The multilayer glass panel may include two glass substrates each carrying an electrode layer with an electrically controllable optically active material interposed between the electrode layers of the two substrates. A laser beam can be directed along an outer face of a first one of the glass substrates forming the multilayer glass panel to form a separation extending at least partially through the thickness of the first glass substrate but not through the thickness of the second glass substrate. A portion of the first glass substrate can then be removed along the separation line to form a shelf defining the electrode engagement region, with the electrode layer on the shelf of the underlying second glass substrate being exposed for mechanically and/or electrically coupling an electrode to the electrode layer on the shelf.

In some implementations, the laser cutting process may involve directing a laser beam into the substrate to be cut at different locations along the intended separation line of the substrate. The laser and substrate can move relative to each other to direct the laser beam into the substrate at the different locations along the separation line. In some examples, filamentation damages in the interior of the glass being cut are created adjacent to one another along a separation line. The filamentation damages, which can also be referred to as filamentation flaws, can be spaced apart from each other along the length of the separation line. Groups of filamentation flaws can be clustered together to form defect columns, with space between adjacent defect columns being devoid of filamentation extending down to the electrode layer.

For example, the laser may be controlled to from a group of spaced-apart filamentation flaws and then moved relative to the substrate along the separation line to form another group of spaced-apart filamentation flaws without forming laser filamentations between the two groups of spaced-apart filamentation flaws that extend down to the underlying electrode layer(s). As a result, the electrode layer carried by the second substrate underlying the first substrate being laser cut may remain electrically conductive (e.g., undamaged) between adjacent groups of spaced-apart filamentation flaws. When an electrode is subsequently attached to a shelf of the second glass substrate formed by laser cutting and removing a portion of the first glass substrate, the electrode can electrically couple with an electrically controllable optically active material via the remaining electrically conductive (e.g., undamaged) regions of the electrode layer located between adjacent groups of spaced-apart filamentation flaws (e.g., defining defect columns).

A variety of different glass and ceramic substrates can be cut using the laser cutting techniques of the present disclosure. In general, such substrates may be formed from glass compositions, such as borosilicate glass, soda-lime glass (e.g., soda-lime silicate glass), aluminosilicate glass, alkali aluminosilicate glass, alkaline earth aluminosilicate glass, alkaline earth boro-aluminosilicate glass, fused silica, or crystalline materials such as sapphire, silicon, gallium arsenide, or combinations thereof. In some examples, a single substrate is laser cut to form a finished workpiece suitable for end use or incorporation in another article being fabricated. In other examples, a multilayer panel may be laser cut from a finished workpiece suitable for end use or incorporation in another article being fabricated. The multilayer panel can be formed of two or more individually fabricated substrates (e.g., each of which can be selected from the foregoing list of example substrates) that are joined together (e.g., via adhesive, fusion, or other bonding mechanism) to provide the resulting multilayer panel.

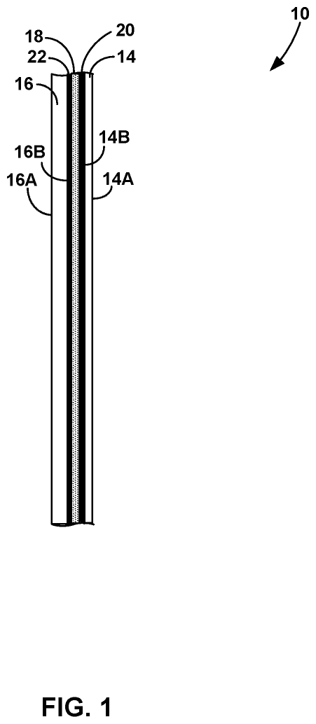

FIG. 1 is a side view of an example multilayer glass panel 10 that maybe laser cut according to the disclosure. Multilayer panel 10 is illustrated as including a first substrate of transparent material 14 and a second substrate of transparent material 16 with a layer of optically active material 18 bounded between the two panes of transparent material. The multilayer panel 10 also includes a first electrode layer 20 and a second electrode layer 22. The first electrode layer 20 is carried by the first substrate of transparent material 14 while the second electrode layer 22 is carried by the second substrate of transparent material. In operation, electricity supplied through the first and second electrode layers 20, 22 can control the optically active material 18 to control visibility through the privacy glazing structure.

As described in greater detail below, one or both of the first and second panes of transparent material 14, 16 may be laser cut to remove a portion of one of the panes from an underlying portion of the other pane. This can recess the edge of the cut substrate relative to the underlying pane, e.g., such that the edge of the underlying substrate extends outwardly relative to the laser cut substrate to define a shelf. An electrode can be attached to the shelf, thereby electrically coupling the electrode to the electrode layer on the shelf and, correspondingly, optically active material 18.

Multilayer panel 10 can utilize any suitable privacy materials for the layer of optically active material 18. Further, although optically active material 18 is generally illustrated and described as being a single layer of material, it should be appreciated that a structure in accordance with the disclosure can have one or more layers of optically active material with the same or varying thicknesses. In general, optically active material 18 is configured to provide controllable and reversible optical obscuring and lightening. Optically active material 18 can be an electronically controllable optically active material that changes direct visible transmittance in response to changes in electrical energy applied to the material.

In one example, optically active material 18 is formed of an electrochromic material that changes opacity and, hence, light transmission properties, in response to voltage changes applied to the material. Typical examples of electrochromic materials are WO₃ and MoO₃, which are usually colorless when applied to a substrate in thin layers. An electrochromic layer may change its optical properties by oxidation or reduction processes. For example, in the case of tungsten oxide, protons can move in the electrochromic layer in response to changing voltage, reducing the tungsten oxide to blue tungsten bronze. The intensity of coloration is varied by the magnitude of charge applied to the layer.

In another example, optically active material 18 is formed of a liquid crystal material. Different types of liquid crystal materials that can be used as optically active material 18 include polymer dispersed liquid crystal (PDLC) materials and polymer stabilized cholesteric texture (PSCT) materials. Polymer dispersed liquid crystals usually involve phase separation of nematic liquid crystal from a homogeneous liquid crystal containing an amount of polymer, sandwiched between electrode layers 20 and 22. When the electric field is off, the liquid crystals may be randomly scattered. This scatters light entering the liquid crystal and diffuses the transmitted light through the material. When a certain voltage is applied between the two electrode layers, the liquid crystals may homeotropically align and the liquid crystals increase in optical transparency, allowing light to transmit through the crystals.

In the case of polymer stabilized cholesteric texture (PSCT) materials, the material can either be a normal mode polymer stabilized cholesteric texture material or a reverse mode polymer stabilized cholesteric texture material. In a normal polymer stabilized cholesteric texture material, light is scattered when there is no electrical field applied to the material. If an electric field is applied to the liquid crystal, it turns to the homeotropic state, causing the liquid crystals to reorient themselves parallel in the direction of the electric field. This causes the liquid crystals to increase in optical transparency and allows light to transmit through the liquid crystal layer. In a reverse mode polymer stabilized cholesteric texture material, the liquid crystals are transparent in the absence of an electric field (e.g., zero electric field) but light scattering upon application of an electric field.

In one example in which the layer of optically active material 18 is implemented using liquid crystals, the optically active material includes liquid crystals and a dichroic dye to provide a guest-host liquid crystal mode of operation. When so configured, the dichroic dye can function as a guest compound within the liquid crystal host. The dichroic dye can be selected so the orientation of the dye molecules follows the orientation of the liquid crystal molecules. In some examples, when an electric field is applied to the optically active material 18, there is little to no absorption in the short axis of the dye molecule, and when the electric field is removed from the optically active material, the dye molecules absorb in the long axis. As a result, the dichroic dye molecules can absorb light when the optically active material is transitioned to a scattering state. When so configured, the optically active material may absorb light impinging upon the material to prevent an observer on one side of privacy glazing structure 12 from clearly observing activity occurring on the opposite side of the structure.

When optically active material 18 is implemented using liquid crystals, the optically active material may include liquid crystal molecules within a polymer matrix. The polymer matrix may or may not be cured, resulting in a solid or liquid medium of polymer surrounding liquid crystal molecules. In addition, in some examples, the optically active material 18 may contain spacer beads (e.g., micro-spheres), for example having an average diameter ranging from 3 micrometers to 40 micrometers, to maintain separation between the first substrate of transparent material 14 and the second substrate of transparent material 16.

In another example in which the layer of optically active material 18 is implemented using a liquid crystal material, the liquid crystal material turns hazy when transitioned to the privacy state. Such a material may scatter light impinging upon the material to prevent an observer on one side of privacy glazing structure 12 from clearly observing activity occurring on the opposite side of the structure. Such a material may significantly reduce regular visible transmittance through the material (which may also be referred to as direct visible transmittance) while only minimally reducing total visible transmittance when in the privacy state, as compared to when in the light transmitting state. When using these materials, the amount of scattered visible light transmitting through the material may increase in the privacy state as compared to the light transmitting state, compensating for the reduced regular visible transmittance through the material. Regular or direct visible transmittance may be considered the transmitted visible light that is not scattered or redirected through optically active material 18.

Another type of material that can be used as the layer of optically active material 18 is a suspended particle material. Suspended particle materials are typically dark or opaque in a non-activated state but become transparent when a voltage is applied. Other types of electrically controllable optically active materials can be utilized as optically active material 18, and the disclosure is not limited in this respect.

Independent of the specific type of material(s) used for the layer of optically active material 18, the material can change from a light transmissive state in which privacy glazing structure 12 is intended to be transparent to a privacy state in which visibility through the insulating glazing unit is intended to be reduced. Optically active material 18 may exhibit progressively decreasing direct visible transmittance when transitioning from a maximum light transmissive state to a maximum privacy state. Similarly, optically active material 18 may exhibit progressively increasing direct visible transmittance when transitioning from a maximum privacy state to a maximum transmissive state. The speed at which optically active material 18 transitions from a generally transparent transmission state to a generally opaque privacy state may be dictated by a variety factors, including the specific type of material selected for optically active material 18, the temperature of the material, the electrical voltage applied to the material, and the like.

Depending on the type of material used for optically active material 18, the material may exhibit controllable darkening. As noted above, controllable darkening refers to the ability of the optically active material to transition between a high visible light transmission state (a bright state), a low visible light transmission dark state, and optionally intermediate states therebetween, and vice versa, by controlling an external energy source applied to the optically active material. When optically active material 18 is so configured, the visible transmittance through the cell containing optically active material 18 (e.g., in addition to other substrates and/or laminate layers bounding the optically active material and forming the cell) may be greater than 40% when optically active material 18 is transitioned to the high visible transmission state light state, such as greater than 60%. By contrast, the visible transmittance through the cell may be less than 5 percent when optically active material 18 is transitioned to the low visible light transmission dark state, such as less than 1%. Visible transmittance can be measured according to ASTM D1003-13.

Additionally or alternatively, optically active material 18 may exhibit controllable light scattering. As noted above, controllable light scattering refers to the ability of the optically active material to transition between a low visible haze state, a high visible haze state, and optionally intermediate states therebetween, and vice versa, by controlling an external energy source. When optically active material 18 is so configured, the transmission haze through the cell containing optically active material 18 may be less than 10% when optically active material 18 is transitioned to the low visible haze state, such as less than 2%. By contrast, the transmission haze through the cell may be greater than 85% when optically active material 18 is transitioned to the high visible haze state and have a clarity value below 50%, such as a transmission haze greater than 95% and a clarity value below 30%. Transmission haze can be measured according to ASTM D1003-13. Clarity can be measured using a BYK Gardener Haze-Gard meter, commercially available from BYK-GARDNER GMBH.

To electrically control optically active material 18, multilayer panel 10 in the example of FIG. 1 includes first electrode layer 20 and second electrode layer 22. Each electrode layer may be in the form of an electrically conductive coating deposited on or over the surface of each respective substrate facing the optically active material 18. For example, first substrate of transparent material 14 may define an outer surface 14A (also referred to as an outer face) and an inner surface 14B (also referred to as an inner face) on an opposite side of the pane. Similarly, second substrate of transparent material 16 may define an outer surface 16A (also referred to as an outer face) and an inner surface 16B (also referred to as an inner face) on an opposite side of the pane. First electrode layer 20 can be deposited over the inner surface 14B of the first pane, while second electrode layer 22 can be deposited over the inner surface 16B of the second pane. The first and second electrode layers 20, 22 can be deposited directly on the inner surface of a respective substrate or one or more intermediate layers, such as a blocker layer, can be deposited between the inner surface of the substrate and the electrode layer.

Each electrode layer 20, 22 may be an electrically conductive coating that is a transparent conductive oxide (“TCO”) coating, such as aluminum-doped zinc oxide and/or tin-doped indium oxide. In some examples, the transparent conductive coatings forming electrode layers 20, 22 define wall surfaces of a cavity between first substrate of transparent material 14 and second substrate of transparent material 16 which optically active material 18 contacts. In other examples, one or more other coatings may overlay the first and/or second electrode layers 20, 22, such as a dielectric overcoat (e.g., silicon oxynitride). In either case, first substrate of transparent material 14 and second substrate of transparent material 16, as well as any coatings on inner faces 14B, 16B of the panes can form a cavity or chamber containing optically active material 18.

For example, one or both of the panes of transparent material 14, 16 bounding the optically active material can have an alignment layer bounding and contacting optically active material 18. The alignment layer can be deposited over any underlying layers carried by the pane, such as an electrode layer, an underlying transparent dielectric blocking layer (e.g., silicone oxide), and/or transparent dielectric overcoat. The alignment layer can help reduce or eliminate Mura (blemish) defects, e.g., by changing the surface energy and/or surface interactions between optically active material 18 and the surface of substrate contacting the optically active material. In one example, the alignment layer is implemented by a layer containing polyimide (e.g., formed by coating the surface with a coating containing polyimide). The polyimide layer may or may not be rubbed to modify the properties of the layer and corresponding interactions with optically active layer 18.

The individual panes of transparent material forming multilayer panel 10, including first substrate 14 and second substrate 16, can be formed of any suitable material, including the example substrate materials discussed above. Each substrate of transparent material may be formed from the same material, or at least one of the panes of transparent material may be formed of a material different than at least one other of the panes of transparent material. In some examples, at least one (and optionally all) the panes of multilayer panel 10 are formed of glass. In other examples, at least one layer of multilayer panel 10 is formed of plastic such as, e.g., a fluorocarbon plastic, polypropylene, polyethylene, or polyester. When glass is used, the glass may be clear or the glass may be colored, depending on the application. Although the glass can be manufactured using different techniques, in some examples the glass is manufactured on a float bath line in which molten glass is deposited on a bath of molten tin to shape and solidify the glass. Such an example glass may be referred to as float glass. When one or more of the panes of multilayer panel 10 are fabricated from glass, one or more of the panes (and optionally all of the panes) may be fabricated from unstrengthened glass or from strengthened glass (e.g., thermally strengthened glass, chemically strengthened glass).

In some examples, the thicknesses of the panes of transparent material 14, 16 forming multilayer panel 10 are each within a range from 0.5 mm to 8 mm, such as from 1 mm to 6 mm, or from 2 mm to 4 mm. Each substrate of transparent material 14, 16 forming multilayer panel 10 may have the same thickness, or one substrate may have a different thickness (greater or less) than the other substrate of transparent material.

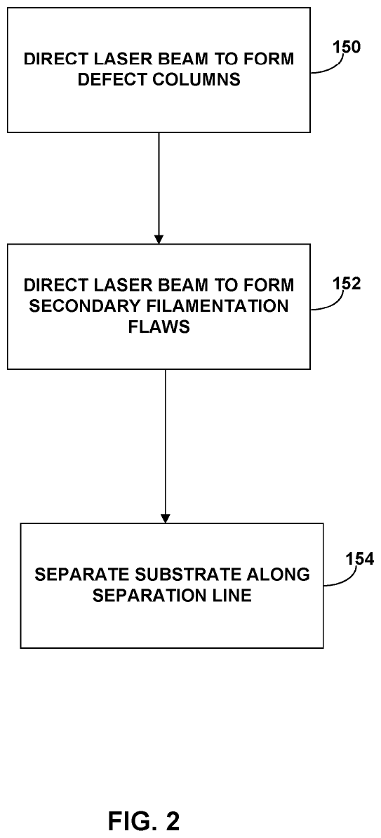

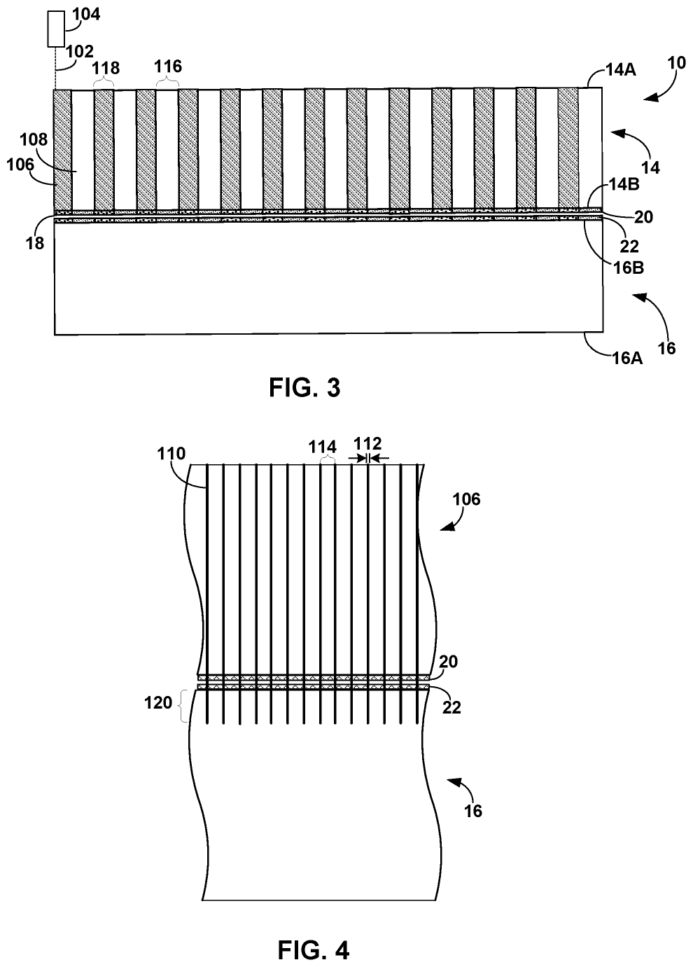

FIG. 2 is a flow chart of an example technique for laser cutting a multilayer panel. The example technique of FIG. 2 will be described in connection with cutting multilayer panel 10 discussed above with respect to FIG. 1 although can be applied on other substrates and multilayer panel configurations. Further, the example technique of FIG. 2 will be described in conjunction with corresponding illustrations in FIGS. 3-6 although likewise can be implemented in other embodiments consistent with the teachings provided herein.

The example technique of FIG. 2 involves directing a laser beam into multilayer panel 10 to form filamentation flaws grouped into defect columns in the panel (150). For example, FIG. 3 is a side sectional view of multilayer panel 10 illustrating a laser beam 102 being directed from a laser 104 into multilayer glass panel 10. Laser 104 can be translated relative to multilayer panel 10 (e.g., by moving the laser relative to a stationary panel or the panel relative to a stationary laser) to form a separation line where one substrate of multilayer panel 10 is to be separated from a remaining portion of the substrate.

As will be discussed in more detail, laser beam 102 can create filamentation damages or flaws adjacent to one another along the separation line in the interior of at least one substrate of multilayer panel 10. For example, laser 104 can emit laser pulses, which impinge on one of the side surfaces (e.g., first surface 14A) of one of the substrates and penetrate at least partially through the thickness into the volume of that substrate. Multilayer panel 10 and laser 104 can be moved relative to each other, with additional filamentation flaws being formed at adjacent spaced-apart locations along the pathway of movement. This can result in a plurality of spaced-apart filamentation flaws extending at least partially through the thickness of the substrate being laser cut.

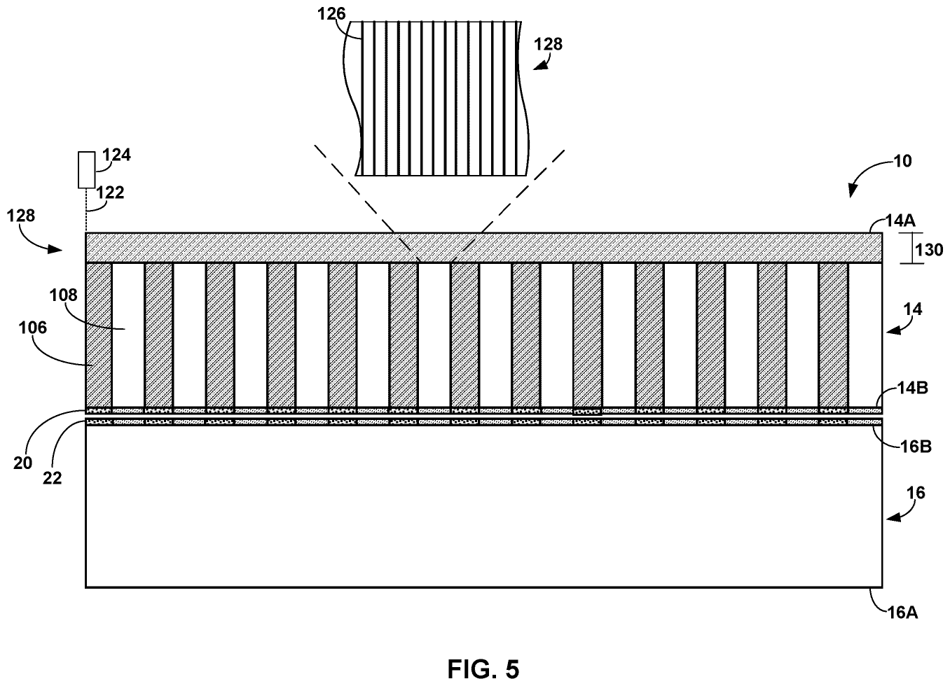

Laser 104 can be controlled to form groups of spaced-apart filamentation flaws defining defect columns 106. Multiple defect columns can be formed defining the separation line where one portion of a substrate is to be separated from a remaining portion of that substrate. For example, one defect column 106 can be formed by forming a group of multiple spaced-apart filamentation flaws. Laser 104 (and/or laser beam 102) can be moved relative to multilayer panel 10 and an adjacent group of multiple spaced-apart filamentation flaws formed in the substrate being cut to define an adjacent defect column 106. Region 108 between adjacent defect columns may remain untreated by laser 104 (e.g., unfilamented) or may be filamented to a lesser depth (e.g., as discussed in connection with FIG. 5).

With reference to FIG. 3, laser beam 102 can be directed into first substrate 14 to form a plurality of spaced-apart defect columns 106 extending at least partially through the thickness of the first glass substrate. For example, spaced-apart defect columns 106 (and the individual spaced-apart filamentation flaws forming each defect column) may extend at least partially through the thickness of first glass substrate 14 but not through the thickness of second glass substrate 16. Spaced-apart defect columns 106 (and the individual spaced-apart filamentation flaws forming each defect column) may extend partially through the thickness of first substrate 14 from first surface 14A toward second surface 14B without extending through the entire thickness of the substrate or, in other examples, may extend through the entire thickness of first substrate 14 and may or may not extend partially through the thickness of second substrate 16.

To remove a portion of first substrate 14 from a remaining portion of the substrate using laser 104, laser beam 102 can be directed at first surface 14A of the substrate, which is the outer face of the substrate where the corresponding interface of the substrate separated by the thickness of the substrate faces electrically controllable optically active material 18. Laser beam 102 can impinge on the outer surface 14A and create a structural defect or weakness extending at least partially through the thickness of first substrate 14 from the outer surface 14A toward the inner surface 14B.

To similarly remove a portion of second substrate 16 from a remaining portion of the substrate using laser 104, laser beam 102 can be directed at first surface 16A of the substrate, which is the outer face of the substrate where the corresponding interface of the substrate separated by the thickness of the substrate faces electrically controllable optically active material 18. Laser beam 102 can impinge on the outer surface 16A and create a structural defect or weakness extending at least partially through the thickness of second substrate 16 from the outer surface 16A toward the inner surface 16B. Accordingly, while FIG. 3 only illustrates first substrate 14 being laser cut using laser 104 for purposes of discussion, it should be appreciated that a mirror process may be performed on second substrate 16 to similar remove a portion of the second substrate from a remaining portion. Also, it should be appreciated that reference to first and second is intended to distinguish different substrates and/or process steps from each other and is not a requirement that a laser cutting process be performed in any particular temporal order. Accordingly, references to first substrate 14 being cut relative to second substrate 16 can be replaced with corresponding references of second substrate 16 being cut relative to first substrate 14.

FIG. 4 is an enlarged side view of an example defect column 106 illustrating an example set of a plurality of spaced-apart filamentation flaws 110 that, collectively, can define an individual defect column 106. Each individual filamentation flaw 110 can be formed by directing laser beam 102 from the first surface 14A toward the second surface 14B at the location where the filamentation flaw is to be formed. In some examples, a pulsed laser beam 120 (e.g., with a beam spot projected onto first substrate 14) may be directed onto the substrate (e.g., condensed into a high aspect ratio line focus that penetrates through at least a portion of the thickness of first substrate 14). This can form a pulsed laser beam focal line.

Laser beam 102 can generate an induced absorption within first substrate 14 (e.g., within the thickness of the substrate) in response to the energy imparted by the laser beam. This induced absorption can change the structural characteristics of first substrate 14 along the pathway of the laser beam, creating a structural flaw that fractures preferentially compared to adjacent regions of the substrate not exposed to energy from laser beam 102.

In practice, laser beam 102 can form a beam spot projected onto first surface 14A of first substrate 14. The beam spot can indicate the intensity cross section of laser beam 102 (e.g., a pulsed laser beam) at a point of first contact with a substrate (e.g., first substrate 102). In different implementations, laser beam 102 can provide an axisymmetric intensity cross section in a direction normal the beam pathway (e.g., an axisymmetric beam spot) or a non-axisymmetric intensity cross section in a direction normal the beam pathway (e.g., a non-axisymmetric beam spot). Axisymmetric generally refers to a shape that is symmetric, or appears the same, for any arbitrary rotation angle made about a central axis, while non-axisymmetric refers to a shape that is not symmetric for any arbitrary rotation angle made about a central axis. A circular beam spot is an example of an axisymmetric beam spot and an elliptical beam spot is an example of a non-axisymmetric beam spot. In either case, laser beam 102 can be pulsed multiple times at a single location on first substrate 14 to form an individual filamentation flaw extending at least partially through the thickness of the substrate.

Further, laser 104 may be translated relative to multilayer panel 10 (e.g., first substrate 14 of the panel) in a translation direction and again activated to direct laser beam 102 on an adjacent region of first substrate 14 to form an adjacent filamentation flaw 110 with spacing between adjacent filamentation flaws (with laser beam 102 being deactivated between flaws). Laser 104 may be translated across multilayer panel 10 by motion of the multilayer panel (e.g., motion of a translation stage coupled to the multilayer panel), motion of laser beam 102 (e.g., motion of the focal line and/or laser 104), or motion of both the multilayer panel and the laser beam. In either case, a plurality of spaced-apart filamentation flaws can be created extending at least partially through the thickness of the substrate being cut, e.g., with spacing between adjacent filamentation flaws being untreated by laser beam 102 down to the underlying electrode layer(s).

The width 112 of each filamentation flaw 110 can be set based on the cross-sectional size of laser beam 102 and can vary, e.g., depending on the configuration of laser 104. In typical configurations, the cross-sectional size of laser beam 102 and the corresponding width 112 of each filamentation flaw 110 may be within a range from 0.5 μm (0.0005 mm) to 2.5 μm (0.0025 mm), such as from one micron (0.001 mm) to 2 μm (0.002 mm). For example, the cross-sectional size of laser beam 102 and the corresponding width 112 of each filamentation flaw 110 may be approximately one micron (0.001 mm) (±10 percent) or approximately 2 μm (0.002 mm) (±10 percent). Each filamentation flaw 110 formed along a separation line may typically have the same width 112, although filamentation flaws having different widths 112 can also be formed along the separation line.

A distance 114 can separate each filamentation flaw 110 from each adjacent filamentation flaw resulting in multiple spaced-apart filamentation flaws. Distance 114, which may be referred to as the pitch, can be measured from the center of one filamentation flaw 110 to the center of an adjacent filamentation flaw 110. In some implementations, distance 114 is within a range from one micron (0.001 mm) to 10 μm (0.01 mm), such as from 4 μm (0.004 mm) to 8 μm (0.008 mm). Distance 114 may be the same between each adjacent filamentation flaw 110 within a particular defect column 106 (FIG. 3) to provide equally spaced filamentation flaws. Alternatively, distance 114 may vary between different pairs of filamentation flaws 110 within a particular defect column 106. When so configured, distance 114 between one or more pairs of adjacent filamentation flaws 110 within a defect column 106 may be different (larger or smaller) than the distance 114 between one or more other pairs of adjacent filamentation flaws 110 within the defect column. This can provide asymmetric spacing between different adjacent filamentation flaws 110 across the width of a defect column 106.

Further, the width(s) 112 of each filamentation flaw 110 and the separation distance(s) 114 between adjacent filamentation flaws may be the same for each defect column 106 formed in multilayer panel 10, or different defect columns may be formed with different filamentation flaw sizing and/or separation. For example, one or more defect columns 106 may be formed of filamentation flaws 110 having a first width or set of widths 112 and a first separation distance or set of separation distances 114, and one or more other defect columns may be formed of filamentation flaws having a second width or set of widths 112 and/or a second separation distance or set of separation distances 114 different than the one or more other defect columns.

Each filamentation flaw 110 can be formed by activating laser 104 to direct laser beam 102 at the location where the filamentation flaw is to be formed for a single activation (e.g., of set duration) or multiple times at that particular location. For example, laser 104 can be activated to direct laser beam 102 at the location where each filamentation flaw 110 is to be formed multiple times providing a pulsed laser beam (e.g., where the laser beam is repeatedly activated and deactivated to provide a burst of discrete pulses of laser energy). The number of burst pulses supplied to form each filamentation flaw 110 may vary, e.g., based on the thickness and material composition of the substrate being cut and/or on the configuration of laser 104. In some examples, laser 104 provides a number of pulses to form each filamentation flaw 110 within a range from 2 to 12 pulses, such as from 3 to 10, or from 4 to 8.

A variety of different laser systems can be used as laser 104 to generate each filamentation flaw 110. The configuration and operating parameters of laser 104 can vary, e.g., based on the thickness and material composition of the substrate being cut and desired processing time to cut a particular substrate. In some examples, laser 104 is implemented to operate at a power within a range from 50 W to 200 W, such as from 70 W to 150 W, and at a frequency within a range from 100 kHz to 200 kHz, such as from 125 kHz to 175 kHz. Laser 104 may be implemented using a picosecond source laser or a femtosecond source laser, which provides burst pulses with each pulse having a duration within a range of a certain number of picoseconds or femtoseconds. For example, laser 104 may be a picosecond laser, which may provide burst pulses with each pulse having a duration within a range from 12 picoseconds to 50 picoseconds Depending on the source, laser 104 may operate at various wavelengths, such as 266 nm, 532 nm, 1060 nm, or 1064 nm.

Each filamentation flaw 110 can extend transversely through the substrate of multilayer panel 10 being cut using laser 104 (e.g., in a direction parallel to the thickness of the substrate). Directing laser beam 102 at the substrate being cut by laser 104 may result in electrical deactivation of the electrode layer carried by that substrate along the propagation line of the laser beam as well as electrical deactivation of the underlying region of the electrode layer carried by the opposed substrate of multilayer panel 10. For example, with reference to FIGS. 3 and 4, when laser beam 102 is directed at outer face 14A of first substrate 14 to form each filamentation flaw 110, a region of first electrode layer 20 underlying where the filamentation flaw is formed may be damaged by the laser beam resulting in that region being electrically deactivated. Further, a corresponding region of second electrode layer 22 also underlying the region where the filamentation flaw 110 is formed may be damaged by the laser beam resulting in that region also being electrically deactivated.

In practice, it has typically been observed that the region of first electrode layer 20 and/or second electrode layer 22 underlying a particular filamentation flaw that is damaged and rendered electrically inactive has a cross-sectional size 1 to 3 times (e.g., approximately two times) the cross-sectional size of laser beam 102 (and corresponding width 112 of the filamentation flaw formed using the laser beam) directed at the overlying region of the substrate being cut. As a result, the extent of damage to first electrode layer 20 and second electrode layer 22 underlying each filamentation flaw 110 formed in first substrate 14 may be greater than the actual size of the filamentation flaw. Accordingly, even though adjacent filamentation flaws 110 may be spaced-apart from each other a distance 114, the enlarged region of electrode layer damage caused by laser beam 102 may result in an electrically deactivated line being formed across second electrode layer 22 underlying the separation line if the spaced-apart filamentation flaws 110 are formed continuously across the substrate being cut.

With reference to FIG. 4, laser 104 can be controlled to form groups of filamentation flaws 110, described herein as spaced-apart defect columns 106, with spacing between adjacent defect columns. When so configured, regions of first electrode layer 20 and/or second electrode layer 22 between adjacent defect columns 106 may remain undamaged by laser beam 102 and remain electrically active. As a result, when one portion of first substrate 14 is separated from an adjacent portion along the separation line formed by laser 104, electrically active regions of second electrode layer 22 remain (e.g., albeit separated by adjacent rejections of the electrode layer damaged and electrically deactivated by the laser beam). Accordingly, electrical energy can pass through the remaining electrically active regions of second electrode layer 22 for controlling electrically controllable optically active layer 18.

The number of filamentation flaws 110 along with the respective width 112 of each filamentation flaw and distance 114 between adjacent filamentation flaws can set the overall size of each defect column 106. A distance 116 can separate each defect column 106 from each adjacent defect column. Distance 116 can be measured from the edge of one defect column (e.g., a lateral-most filamentation flaw 110 forming a side edge of one defect column) to the adjacent edge of the adjacent defect column (e.g., a lateral-most filamentation flaw 110 forming an adjacent side edge of an adjacent defect column). Distance 116 separating adjacent defect columns 106 may be significantly larger than distance 114 separating adjacent filamentation flaws 110 to provide a defined separation between adjacent groups of filamentation flaws defining adjacent defect columns. In various examples, distance 116 may be at least 0.05 mm, such as at least 0.1 mm, at least 0.2 mm, at least 0.3 mm, at least 0.4 mm, at least 0.5 mm, at least 0.6 mm, or at least 0.7 mm.

In general, increasing distance 116 separating adjacent defect columns 106 increases the size of regions 108 between adjacent defect columns and, correspondingly, the size of the regions of second electrode layer 22 underlying regions 108 that may remain electrically active after formation of defect columns 106. However, distance 116 separating adjacent defect columns 106 may be sufficiently small to ensure fracturing of one portion of first substrate 14 relative to the remaining portion of the substrate along the separation line defined by defect columns 106. Accordingly, in some examples, distance 116 between adjacent defect columns 106 may be less than 2.0 mm, such as less than 1.5 mm, less than 1.0 mm, less than 0.9 mm, less than 0.8 mm, less than 0.7 mm, less than 0.6 mm, or less than 0.5 mm. Any of these example upper limits for distance 116 may be combined with any of the aforementioned example lower limits to define a bounded range of pairs for distance 116. For instance, distance 116 separating adjacent defect columns 106 may be within a range from 0.1 mm to 1.0 mm, such as from 0.2 mm to 0.8 mm, from 0.3 mm to 0.7 mm, from 0.4 mm to 0.6 mm, or approximately 0.5 mm (e.g., ±10 percent).

Distance 116 may be the same between each adjacent defect column 106 along a separation line to provide equally spaced defect columns. Alternatively, distance 116 may vary between different pairs of defect columns 106 to provide asymmetrically spaced defect columns. When so configured, distance 116 between one or more pairs of adjacent defect columns 106 may be different (larger or smaller) than the distance 116 between one or more other pairs of adjacent defect columns 106.

Each defect column 106 may define a width 118 (extending in a direction transverse to the thickness of the substrate through which the defect column extends). The width 118 of each defect column may be measured from the lateral-most filamentation flaw defining one side of the defect column (e.g., which is bounded by a separation distance 116 separating the filamentation flaw from an adjacent defect column) to the lateral-most filamentation flaw defining the opposite side of the defect column (e.g., which is bounded by separation distance 116 separating the filamentation flaw from an adjacent defect column). The width 118 of each defect column 106 may be controlled by controlling the number of individual spaced-apart filamentation flaws 110 formed in series to define the defect column as well as the size 112 of each filamentation flaw in the distance 114 between adjacent filamentation flaws.

In some examples, the width 118 of each defect column 106 may be at least 0.05 mm, such as at least 0.1 mm, at least 0.2 mm, at least 0.3 mm, at least 0.4 mm, at least 0.5 mm, at least 0.6 mm, or at least 0.7 mm. Additionally or alternatively, the width 118 of each defect column 106 may be less than 2.0 mm, such as less than 1.5 mm, less than 1.0 mm, less than 0.9 mm, less than 0.8 mm, less than 0.7 mm, less than 0.6 mm, or less than 0.5 mm. For example, the width 114 separating adjacent defect columns 106 may be within a range from 0.1 mm to 1.0 mm, such as from 0.2 mm to 0.8 mm, from 0.3 mm to 0.7 mm, from 0.4 mm to 0.6 mm, or approximately 0.5 mm (e.g., ±10 percent). The width 118 of each defect column 106 may be the same along a separation line to provide equally sized defect columns. Alternatively, different defect columns 106 along a separation line may exhibit different widths 118 such that one or more defect columns along the separation line have a different width (larger or smaller) than the width of one or more another defect columns along the separation line.

In some examples, the width 118 of the spaced-apart defect columns 106 may be set relative to the spacing distance 116 between adjacent defect columns. The spacing distance 116 between adjacent defect columns may define regions 108 devoid of laser-induced defects. For example, the entire thickness of first substrate 14, a portion of first substrate 14 located closer to second surface 14B than first surface 14A, and/or a region of first electrode layer 20 and/or second electrode layer 22 underlying regions 108 defined by spacing distance 116 between adjacent defect columns 106 may be devoid of laser-induced defects (e.g., damage caused by laser beam 102).

In general, increasing the width 118 of the defect columns 106 and reducing the distance 116 between adjacent defect columns causes more damage to first substrate 14 to promote separation of one portion of the substrate from an adjacent portion of the substrate. However, increasing the width 118 of defect columns 106 and reducing the distance 116 between adjacent defect columns may increase the amount of damage to the region of the first electrode layer 20 and/or second electrode layer 22 underlying each defect column. By contrast, reducing the width 118 of defect columns 106 and increasing the distance 116 between adjacent defect columns reduces the amount of damage to the regions of first electrode layer 20 and/or second electrode layer 22 underlying each defect column. However, reducing the width 118 of defect columns 106 and increasing in the distance 116 between adjacent defect columns reduces the amount of damage to first substrate 14 needed to promote separation of one portion of the substrate from adjacent portion. Accordingly, the width 118 of each defect column 106 may be sized relative to the distance 116 between adjacent defect columns, e.g., to balance the breakout characteristics of first substrate 14 along the separation line as well as the residual electrical characteristics of second electrode layer 22 after breakout.

In some examples, the total width of regions 108 between defect columns 106 (e.g., regions devoid of laser-induced defects) can be determined by summing the combined distances 116 between adjacent spaced-apart defect columns along the length of a separation line. Similarly, the total width of the spaced-apart defect columns 106 can be determined by summing the combined widths 118 of the defect columns along the length of the separation line. In some implementations, a ratio of the combined width of the regions 108 devoid of laser-induced defects divided by the combined width of the plurality of spaced-apart defect columns 106 is within a range from 5:1 to 1:5, such as from 3:1 to 1:2, from 2:1 to 2:3, or from approximately 1:1 (e.g., ±10 percent).

In general, the length of each filamentation flaw 110 (extending parallel to the thickness of first substrate 14) and the corresponding length of each defect column 106 defined by the plurality of spaced-apart filamentation flaws can be controlled, e.g., by controlling the operating parameters of laser 104, such as the operating power and number of pulses. The length of each filamentation flaw 110 may be controlled to ensure sufficient filamentation through the bottom of the upper substrate (through second surface 14B of first substrate 14) and/or limited damage to the lower substrate (second substrate 16).

Each filamentation flaw 110 can be formed to extend at least partially through the thickness of first substrate 14. In some examples, one or more (optionally all) of the filamentation flaws 110 extend partially through the thickness of first substrate 14 (from first surface 14A toward second surface 14B) without extending through the entire thickness of the substrate (e.g., without extending through second surface 14B of the substrate). In other examples, one or more (optionally all) of the filamentation flaws 110 extend fully through the thickness of first substrate 14. For example, the one or more filamentation flaws 110 may extend from first surface 14A through second surface 14B. If the one or more filamentation flaws 110 do not penetrate second surface 14B of the first substrate 14 being cut, additional breakout force may be required to separate the substrate along the separation line, which increase the likelihood of defects during breakout.

If the one or more filamentation flaws 110 pass through the entirety of the underlying second substrate 16, this can result in unintentional removal of a corresponding portion of the second substrate when intending to remove only and overlying portion of the first substrate or weaken the mechanical strength of the resulting offset shelf formed after removing the overlying portion of the first substrate. Accordingly, the length of the one or more filamentation flaws 110 (optionally all of the filamentation flaws 110) may be controlled so the filamentation flaws do not extend through the entire thickness of second substrate 16. For example, the length of the one or more filamentation flaws 110 may be controlled so that the filamentation flaws extend through the entire thickness of first substrate 14 but do not extend through any portion of the thickness of second substrate 16 or extend through a portion of the thickness of second substrate 16 less than the entire thickness of the substrate.

For instance, in some examples, one or more filamentation flaws 110 (optionally all of the filamentation flaws 110) may have a length extending through the entire thickness of first substrate 14 (from first surface 14A through second surface 14B) and may extend partially through the thickness of second substrate 16 (from second surface 16B toward first surface 16A). For example, the one or more filamentation flaws 110 may have a length extending through the entire thickness of first substrate 14 and may extend partially through the thickness of second substrate 16 to a depth 120 (FIG. 4) less than 1 mm below the second surface 16B of the substrate, such as less than 0.5 mm below the second surface, less than 0.4 mm below the second surface, or less than 0.3 mm below the second surface. For example, the one or more filamentation flaws 110 may extend from first surface 14A of first substrate 14 to a depth 120 within a range from 0.05 mm to 0.75 mm below second surface 16B of second substrate 16 (at which point the one or more filamentation flaws terminate), such as a depth within a range from 0.1 mm to 0.5 mm, or within a range from 0.2 mm to 0.4 mm.

With further reference to FIG. 1, the example technique includes optionally directing a laser beam across the separation line initially created and defined by the plurality of spaced-apart defect columns 106 to form one or more subsequent sets of filamentation flaws (152). For example, after translating laser beam 102 relative to multilayer panel 10 across the length of the multilayer panel desired to be cut, thereby forming a separation line along that length, one or more subsequent laser beams can be passed across the previously formed separation line to form one or subsequent sets of spaced-apart filamentation flaws. The one or more subsequent sets of spaced-apart filamentation flaws may be different in one or more dimensional and/or placement characteristics (e.g., different size and/or location) than the one or more filamentation flaws 110 formed when initially directing the laser beam into the multilayer panel.

For example, FIG. 5 is a side sectional view of multilayer panel 10 illustrating a secondary laser beam 102 being directed from a secondary laser 124 into multilayer glass panel 10 along the separation line defined by the previously-formed spaced-apart defect columns 106. Secondary laser 124 can be translated relative to multilayer panel 10 (e.g., by moving the laser relative to a stationary panel or the panel relative to a stationary laser) to form one or more secondary filamentation flaws 126.

Secondary laser 124 can be the same laser as laser 104 used to create filamentation flaws 110 (e.g., operating under the same or different operating conditions), or secondary laser 124 may be a different laser than laser 104. Secondary laser 124 can create filamentation damages or flaws adjacent to one another extending into the interior of at least one substrate of multilayer panel 10. For example, secondary laser 124 can create a plurality of spaced-apart secondary filamentation flaws 126 that are spaced-apart along a co-linear length of the separation line defined by the plurality of spaced-apart defect columns 106. Secondary laser 124 can emit laser pulses, which impinge on one of the side surfaces (e.g., first surface 14A) of one of the substrates and penetrate at least partially through the thickness into the volume of that substrate. Multilayer panel 10 and laser 104 can be moved relative to each other, with additional filamentation flaws being formed at adjacent spaced-apart locations along the pathway of movement. This can result in a plurality of spaced-apart secondary filamentation flaws 126 extending at least partially through the thickness of the substrate being laser cut.

One or more sets of secondary filamentation flaws 126 can be made through one or more secondary passes of laser beam 122 using one or more secondary lasers 124. The one or more sets of secondary filamentation flaws 126 can be formed in a variety of locations relative to the plurality of spaced-apart defect columns 106 previously formed in the multilayer panel 10. For example, one or more secondary filamentation flaws 126 can be formed interdigitated with the filamentation flaws 110 defining each defect column 106, can be formed in the regions 108 between adjacent spaced-apart defect columns 106, and/or in a region extending across both spaced-apart defect columns 106 and the regions 108 between adjacent spaced-apart defect columns.

Each of the one or more secondary filamentation flaws 126 can have any of the widths, lengths, and/or separation distances between adjacent filamentation flaws described above as being suitable for filamentation flaws 110. In some examples, the plurality of spaced-apart secondary filamentation flaws 126 extend into multilayer panel 10 a distance less than the distance filamentation flaws 110 extend into multilayer panel 10.

For example, in the configuration of FIG. 5, the plurality of spaced-apart secondary filamentation flaws 126 are illustrated as forming a cap 128 extending along the separation line formed on multilayer panel 10 and defined by defect columns 106. When so configured, the plurality of spaced-apart secondary filamentation flaws 126 may extend partially but not fully through the thickness of the substrate being cut (e.g., first substrate 14 in the example of FIG. 5). For example, each of the plurality of spaced-apart secondary filamentation flaws 126 may extend from a first surface 14A of first substrate 14 toward second surface 14B of the substrate less than the entire thickness of the substrate, such as to a depth as less than 80% of the entire thickness of the substrate, a depth less than 70% of the entire thickness of the substrate, a depth less than 60% of the entire thickness of the substrate, a depth less than 50% of the entire thickness of the substrate, a depth less than 40% of the entire thickness of the substrate, a depth less than 30% of the entire thickness of the substrate, or a depth less than 20% of the entire thickness of the substrate.

In some examples, one or more (optionally all) of the spaced-apart secondary filamentation flaws 126 extend from the first surface 14A of first substrate 14 toward second surface 14B to a depth 130 at least 0.2 mm above the second surface 14B of the substrate (such that there is at least 0.2 mm between the end of the secondary filamentation flaw and second surface 14B), such as at least 0.5 mm above the second surface, at least 0.8 mm above the second surface, at least 1.2 mm above the second surface, at least 1.5 mm above the second surface, at least 2 mm above the second surface, or at least 2.5 mm above the second surface. In some examples, the spaced-apart secondary filamentation flaws 126 have a length extending from first surface 14A to the terminal end of the filamentation flaws ranging from 0.1 mm to 2 mm, such as from 0.5 mm to 1.5 mm, or from 0.5 mm to 1.0 mm.

When utilizing spaced-apart secondary filamentation flaws 126, the secondary filamentation flaws can be formed extending partially or fully along the length of the separation line defined by the spaced-apart defect columns 106 and separating regions 108 between the spaced-apart defect columns. For example, the spaced-apart secondary filamentation flaws 126 may be formed across substantially an entire length of the separation line along which the substrate is intended to be separated (e.g., along which defect columns 106 were previously formed). In various examples, the spaced-apart secondary filamentation flaws 126 may be formed across at least 50% of the total length of the separation line, such as at least 60% of the total length, at least 70% of total length, at least 80% of the total length, at least 90% of total length, or at least 95% of the total length.

In some examples, the spaced-apart secondary filamentation flaws 126 are formed continuously (one after another with adjacent spacing between each filamentation flaw) over a length of multilayer panel 10 that includes previously formed defect columns 106 (comprising individual filamentation flaws 110) and separating regions 108 between adjacent defect columns. For example, the spaced-apart secondary filamentation flaws 126 may be formed in between and/or overlapping with a portion of the filamentation flaws 110 defining each defect column 106 and within each region 108 devoid of filamentation flaws 110 between adjacent defect columns.

In the example of FIG. 5, for instance, the spaced-apart secondary filamentation flaws 126 are illustrated as extending across the entire length of the separation line defined by spaced-apart defect columns 106 (and being co-linear in the X-Y plane therewith, with the thickness of the substrate being in the Z-direction). This can form a substantially continuous cap 128 bridging over the plurality of spaced-apart defect columns 106 and adjacent regions 108 otherwise devoid of laser-induced defects. When so configured, each region of the substrate devoid of laser-induced defects may be bounded on one lateral side by one defect column 106, on an opposite lateral side by another defect column 106, and on an outward facing side by cap 128. Adding spaced-apart secondary filamentation flaws 126 over and/or in between defect columns 106, e.g., such as in the form of a top cap 128, can be useful to separation of one portion of the substrate being cut from adjacent portion. For example, cap 128 can provide a continuous series of flaws along which substrate 14 can fracture (bridging between adjacent defect columns) while still maintaining the integrity and electrical conductivity of the regions of first electrode layer 20 and/or second electrode layer 22 underlying separating regions 108.

While the example of FIG. 5 illustrates first substrate 14 with defect columns 106 formed by groups of filamentation flaws 110 and spaced-apart secondary filamentation flaws 126, more than two groups of filamentation flaws may be formed in the substrate using one or more additional laser processing passes. For example, using either the same laser or a different laser from that used to form the prior spaced-apart filamentation flaws, one or more additional sets of spaced-apart filamentation flaws may be formed in the substrate, having different dimensional characteristics and/or positioned at different locations from the previously formed filamentation flaws.

With further reference to FIG. 2, and independent of the number of filamentation flaw groups formed in the substrate being cut, the example technique involves separating a portion of one glass substrate (e.g., first substrate 14) from another glass substrate (e.g., second substrate 16) along the separation line of spaced-apart defect columns formed by laser 104 (154). For example, following the formation of the separation line extending at least partially through first substrate 14 but not through second substrate 16, a stress inducing source, such as a mechanical or thermal source may be utilized to separate the first substrate into a removed portion and a remaining portion along the separation line.

In some examples, the thermal source, such as an infrared laser beam, may be used to create thermal stress and thereby separate the substrate at the separation line. For example, an infrared laser may be used to initiate spontaneous separation and then the separation may be finished mechanically. Example infrared lasers used to create thermal stress in glass may typically have wavelengths that are readily absorbed by glass, such as wavelengths ranging from 1.2 microns to 13 microns, for example, from 4 microns to 12 microns. In some examples, an infrared laser beam is directed along the separation line (without or without top cap as discussed above) to promote separation along the separation line. Example infrared laser sources include a carbon dioxide laser (a “CO2 laser”), a carbon monoxide laser (a “CO laser”), a solid state laser, a laser diode, or combinations.

In either case, a thermal source may be controlled to rapidly increase the temperature of multilayer panel 10 (particularly first substrate 14) at or near the separation line. This rapid heating may build compressive stress in the glass substrate on or adjacent to the separation line. Since the area of the heated glass surface is relatively small compared to the overall surface area of the substrate, the heated area cools relatively rapidly. The resultant temperature gradient may induce tensile stress in the glass substrate sufficient to propagate a crack along the separation line and through the thickness of first substrate, resulting in full separation of first substrate 14 along the separation line.

In some examples, the separation line formed in first substrate 14 is configured (e.g., sized and/or positioned) to remove one portion of the first substrate from a remaining portion of the first substrate, with the removed portion also being separated from second substrate 16 while the remaining portion remains joined to the second substrate. The separation line formed in first substrate 14 may be configured so that second substrate 16 defines an underlying shelf upon removal of an overlying portion of first substrate 14.

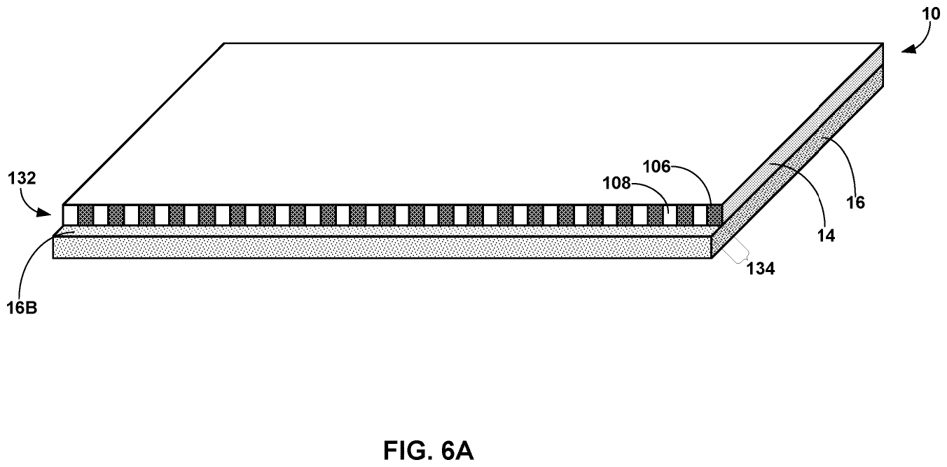

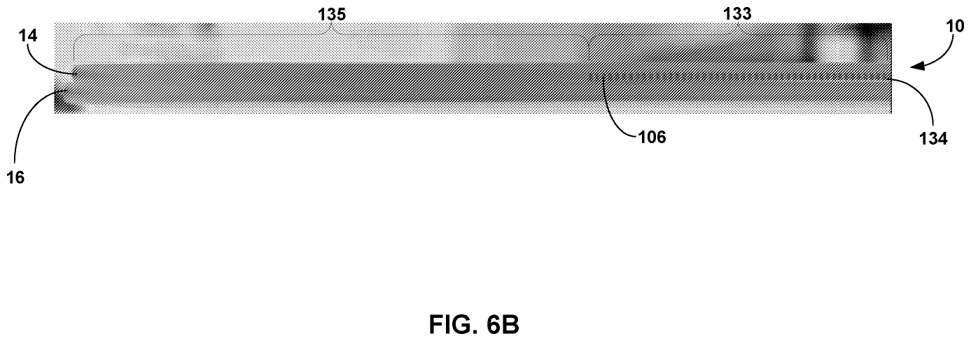

FIG. 6A is a perspective view of an example configuration of multilayer panel 10 after a portion of first substrate 14 has been separated from a remaining portion to provide a shelf defined by a portion of second substrate 16 extending outwardly from a separation line. In particular, the illustrated example shows a separation line 132 formed in multilayer panel 10 using example laser cutting techniques discussed herein. The side edges of first substrate 14 and second substrate 16 may initially be flush with each other, and separation line 132 offset from a flush edge. A portion of first substrate 14 may be removed that extends from the edge of the first substrate (e.g., substantially coplanar with the remaining edge of second substrate 16) to separation line 132. As a result, a shelf 134 may be defined by a portion of second substrate 16 previously underlying the portion of first substrate 14 removed by the laser cutting process. Shelf 134 can be a region of second substrate 16 extending outwardly from separation line 132 to the edge of the substrate. A portion of second surface 16B of second substrate 16 (carrying second electrode layer 22) can by exposed by shelf 134 upon removal of the overlying portion of first substrate 14. This can provide a location where an electrode can be connected to the exposed electrode layer.

FIG. 6A illustrates an example view of multilayer panel 10 where a portion of first substrate 14 is removed from a remaining portion of the substrate to configure second substrate 16 with shelf 134 extending outwardly from separation line 132 (e.g., with second surface 16B of the shelf being exposed for electrically connecting an electrode to second electrode layer 22 on the shelf). Additionally or alternatively, a separation line may be formed through second substrate 16 (e.g., from the opposite direction of multilayer panel 10 from separation line 132) according to the techniques herein and a portion of second substrate 16 removed from a remaining portion of the substrate. This can additionally or alternatively configure first substrate 14 with a shelf extending outwardly from the separation line (e.g., with second surface 14B of the shelf being exposed for electrically connecting an electrode to first electrode layer 20 on the shelf).

The resulting laser cut multilayer panel 10 may include first substrate 14 having inner face 14B and outer face 14A and second substrate 16 having inner face 14B and outer face 14A, with the two substrates being joined together with the inner faces of the substrates facing each other. The two substrates can be joined together via adhesive, fusion, and/or other bonding agent and/or mechanism to hold the substrates together. Electrically controllable optically active material 18 can be positioned between the inner faces of the substrates. For example, electrically controllable optically active material 18 can be positioned between first electrically conductive layer 20 carried by inner face 14B of first substrate 14 and second electrically conductive layer 22 carried by inner face 16B of second substrate 16, with the two electrically conductive layers being arranged to electrically control the electrically controllable optically active material. The first substrate 14, second substrate 16, and electrically controllable optically active material 18 can define multilayer panel 10 having a first side edge and a second side edge. The first side edge can a first shelf (e.g., shelf 134) comprising a portion of second substrate 16 extending outwardly from a cut edge of the first glass substrate and/or the second side edge can define a second shelf comprising a portion of the first substrate 14 extending outwardly from a cut edge of the second substrate. One or both cut edges can include a plurality of spaced-apart defect columns 106 extending at least partially through the edge of the cut substrate but not through the underlying substrate, with each of the plurality of spaced-apart defect columns being defined by a plurality of spaced-apart filamentation flaws 110.

As discussed above, configuring multilayer panel 10 with one or more shelves cut using spaced-apart filamentation flaws 110 grouped into spaced-apart defect columns 106 can be beneficial to maintain electrical conductivity of the region of the electrode layer underlying the cut line in lieu of electrically deactivating the electrode layer in the region underlying the cut line. In different implementations, an entire edge of multilayer panel 10 may be cut using spaced-apart filamentation flaws 110 grouped into spaced-apart defect columns 106 as discussed above, or a portion of the edge less than the entire length of the edge may be cut using spaced-apart filamentation flaws 110 grouped into spaced-apart defect columns 106.

For example, a side of multilayer panel 10 may be cut along one or more regions of using continuous spaced-apart filamentation flaws 110 (without separating the spaced-apart filamentation flaws into spaced-apart defect columns 106) with one or more other regions of the edge cut using spaced-apart filamentation flaws 110 separated into spaced-apart defect columns 106. FIG. 6B is a side view of an example configuration of multilayer panel 10 that is partially cut along its length with a continuous series of filamentation flaws and partially cut along its length with filamentation flaws grouped into defect columns.

FIG. 6B illustrates multilayer panel 10 where a portion of first substrate 14 is removed from a remaining portion of the substrate to configure second substrate 16 with shelf 134 extending outwardly. In this example, the separation line formed in multilayer panel 10 to remove a portion of first substrate 14 from a remaining portion includes one or more regions 133 cut using spaced-apart filamentation flaws separated into spaced-apart defect columns 106, as discussed herein. The separation line formed in multilayer panel 10 to remove a portion of first substrate 14 from a remaining portion also includes one or more regions 135 cut using a continuous series of spaced-apart filamentation flaws without grouping the filamentation flaws into spaced-apart defect columns 106 or providing separation space between such spaced-apart defect columns. The continuous series of spaced-apart filamentation flaws may be formed using spaced-apart filamentation flaws 110 as discussed herein without providing a separating space associated with adjacent defect columns 106. When so configured, the region of second substrate 16 underling the region 135 of the separation line may not carry an electrode layer, or the electrode layer may be electrically deactivated as a result of the continuous series of filamentation flaws. For example, first substrate 14 may be cut from each peripheral (e.g., side) edge inwardly over regions 135 that include a continuous series of filamentation flaws, with an intermediate region 133 being formed of spaced-apart filamentation flaws separated into spaced-apart defect columns. While the forgoing discussion of different cut regions 133, 135 has been described with respect to cut regions formed on first substrate 14, it should be appreciated that a similar arrangement of cut regions can additionally or alternatively be formed on second substrate 16.

The laser cutting techniques of the present disclosure can be used to cut a variety of different substrates for a variety of different applications. In some implementations, the techniques of the present disclosure may be used to cut one or more regions of a mother sheet, where the mother sheet includes multiple different zones of electrically controllable optically active material positioned between opposed substrates each carrying an electrode layer. Each zone can be cut away from each other zone of the mother sheet to form a multilayer panel 10 as described herein.

To form a mother sheet, two substrates (e.g., glass panels) may be prepared by coating an electrode layer on each substrate. Each electrode layer may be patterned to define an electrode layer layout desired for an electrically controllable optically active structure to be subsequently cut from the substrates. Multiple different zones may be patterned on each electrode layer corresponding to multiple different electrically controllable optically active structures to be cut from the substrates. The two substrates may be placed in apposition to each other, with the patterned electrode layer on one substrate being aligned with a corresponding patterned electrode layer on the other substrate. An electrically controllable optically active material can be deposited in each zone (e.g., between the patterned electrode layers in each zone corresponding to an electrically controllable optically active structure to be cut from the substrates) before, during, and/or after joining of the two substrates together. Further, one or more sealants may be deposited in each zone (e.g., surrounding the patterned electrode layers and/or electrically controllable optically active material in each zone) to join the two substrates together (e.g., deposited before placing the two substrates in apposition and pressing the substrates together). The resulting joined substrates can define a mother sheet having multiple different zones, with each zone including an electrically controllable optically active material positioned between two patterned electrode regions. Laser cutting techniques according to the present disclosure can then be used to cut one or more (e.g., optionally all) of the zones out of the mother sheet to provide a cut multilayer panel 10.

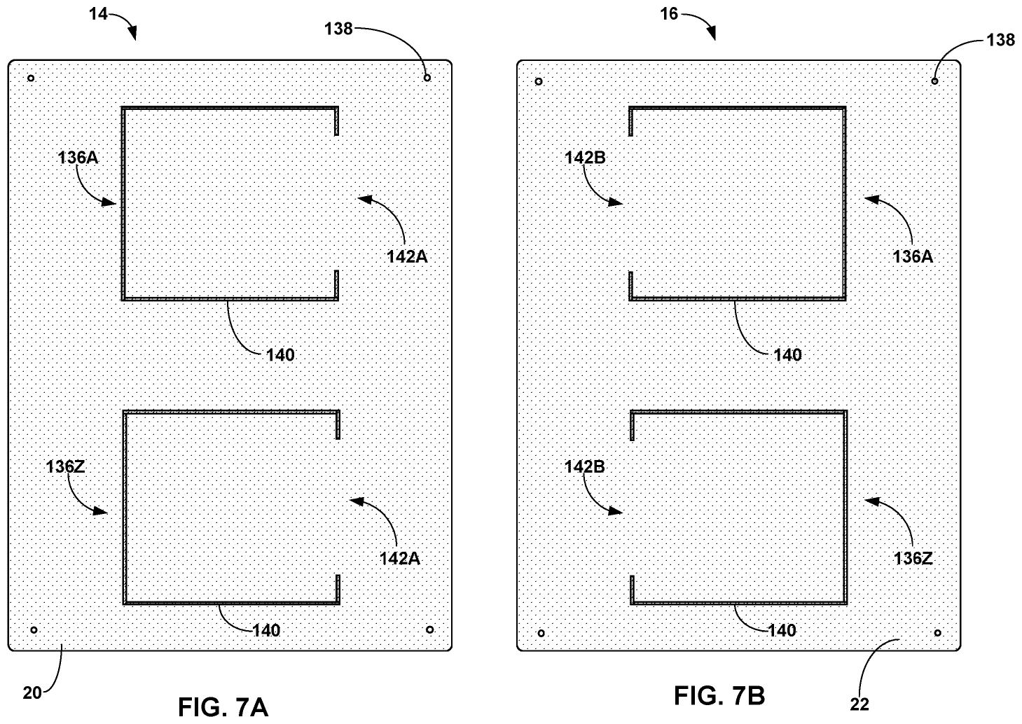

FIGS. 7A and 7B are top views of example configurations of first substrate 14 and second substrate 16, respectively, that can be used to form a mother sheet defining multiple zones of electrically controllable optically active material that can be cut out using the laser cutting techniques of the present disclosure. FIG. 7A illustrates first substrate 14 carrying first electrode layer 20 on an underside of the substrate with multiple zones 136A-136Z (which in the illustrated example are shown as two zones) defining different electrode layer patterned regions for controlling different zones of electrically controllable optically active material to be deposited therein. FIG. 7B similarly illustrates second substrate 16 carrying second electrode layer 22 on a topside of the substrate with multiple corresponding zones 136A-136Z (which in the illustrated example are shown as two zones) defining different electrode layer patterned regions for controlling different zones of electrically controllable optically active material to be deposited therein.

To assemble a mother sheet from the example substrates of FIGS. 7A and 7B, the first substrate 14 can be positioned overlaying the second substrate 16 with corresponding zones 136A-136Z and electrode layer patterned regions defined thereby aligned with each other. In some implementations, one or more alignment markers 138 may be arrayed on each substrate. The alignment markers 138 on the two different substrates can be aligned with each other when overlapping the two sheets to ensure that the different zones defined by each sheet are accurately aligned. An electrically controllable optically active material can be deposited in each zone. In addition, one or more sealants can be deposited in each zone (e.g., defining a perimeter about the electrically controllable optically active material deposited in each zone). The one or more sealants can bond first substrate 14 to second substrate 16, when the two substrates are pressed together.

As shown in FIGS. 7A and 7B, each electrode layer patterned region may form an electrode isolation region 140. Electrode isolation region 140 may be an electrically deactivated region that does not conduct electricity. The electrode isolation region 140 may be formed using a variety of different techniques, such as via grinding and/or laser ablation over the desired region. Alternatively, the electrode layers may be deposited on the substrates so that the electrode layers do not extend over the electrode isolation region 140 (e.g., via masking).

In the illustrated example of FIGS. 7A and 7B, the electrode isolation region 140 is illustrated as extending about a perimeter of an electrically controllable optically active structure to be cut from the mother sheet formed by joining the two substrates together with the exception of electrode contact pads 142A and 142B. Each electrode contact pad 142A and 142B may be form a boundary wall of a recessed space on each substrate (otherwise circumscribed by electrode isolation region 140) where an electrode can be bonded to a corresponding contact pad for controlling the electrode layer, after the electrically controllable optically active structure is cut from the mother sheet formed by joining the two substrates together. For example, after cutting an electrically controllable optically active structure from the mother sheet formed by joining the two substrates together, a first electrode can be connected to electrode contact pad 142B for controlling second electrode layer 22 within the region circumscribed by electrode isolation region 140 and a second electrode can be connected to electrode contact pad 142A for controlling first electrode layer 20 within the region circumscribed by electrode isolation region 140.

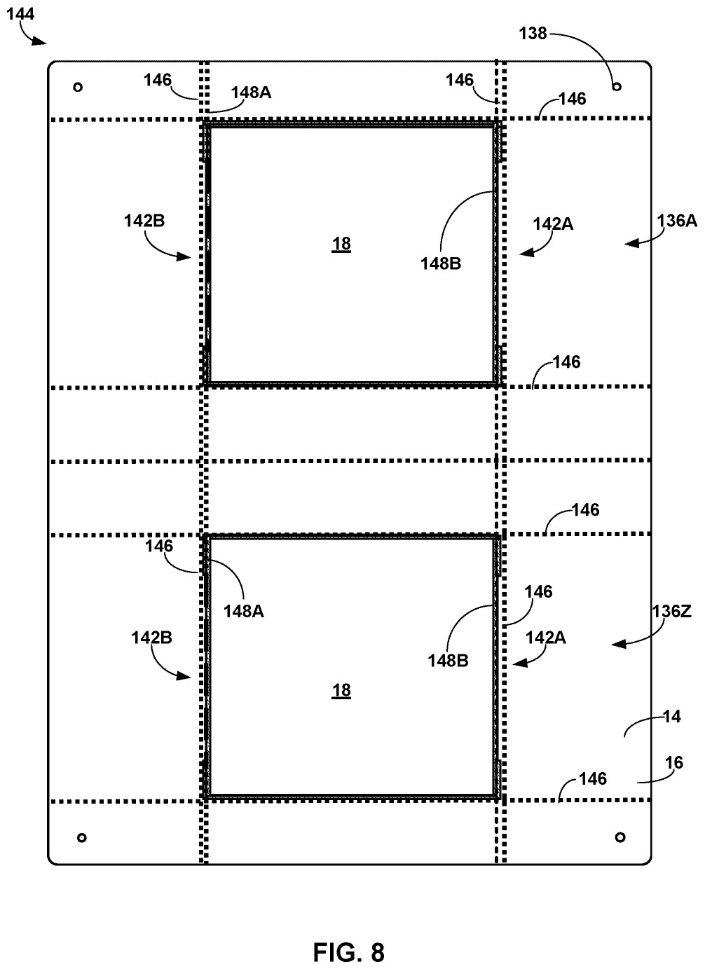

FIG. 8 is a top view of an example mother sheet 144 formed by overlaying and joining first substrate 14 (FIG. 7A) and second substrate 16 (FIG. 7B). In the illustrated example, electrode layer patterned regions corresponding to different zones 136A-136Z on first substrate 14 and second substrate 16 are aligned with each other, with electrically controllable optically active material 18 deposited in each of the different zones. In this example, alignment markers 138 on each substrate are aligned with each other.

To separate each of the plurality of defined zones 136A-136Z corresponding to different electrically controllable optically active structures being fabricated from mother sheet 144, the mother sheet can be cut along cut lines 146. Cut lines 146 can define top, bottom, and first and second side edges of the structure cut from the mother sheet. Mother sheet 144 can be cut along cut lines 146 using a variety of different techniques, including laser cutting (e.g., continuous filamentation without forming groups of defect columns) and/or mechanical scoring and breaking. Before or after cutting the different electrically controllable optically active structures being fabricated (e.g., the zones) from mother sheet 144 along cut lines 146, an edge shelf may be cut on one or more sides of each of the electrically controllable optically active structures being fabricated to remove a residual portion of the mother sheet and expose an underlying shelf. For example, each electrically controllable optically active structures being fabricated from mother sheet 144 can be cut along cut lines 148A and 148B using the laser cutting techniques of the present disclosure.

For example, each of cut lines 148A and 148B can formed by directing a laser beam into first substrate 14 and second substrate 16, respectively, thereby forming a separation line that includes a plurality of space-apart defect columns extending at least partially through the first substrate and second substrate, respectively, but not through the opposite substrate. Laser 104 can be directed along one side of mother sheet 144 to form cut line 148A, either the laser or the mother sheet flipped (e.g., rotated 180 degrees), and the laser then directed along the opposite side of the mother sheet to form cut line 148B. Each of the plurality of space-apart defect columns can include a plurality of spaced-apart filamentation flaws. One portion of first substrate 14 can be separated from the remaining portion of the substrate along cut line 148A to form a shelf exposing a portion of second substrate 16 that includes electrode contact pad 142B. One portion of second substrate 16 can be separated from the remaining portion of the substrate along cut line 148B to form a shelf exposing a portion of first substrate 14 that includes electrode contact pad 142A. Electrodes can then be connected to the electrode contact pads on the two shelves.

A laser-cut multilayer panel according to the disclosure can be used in a variety of different applications, either as a finished product or to be incorporated into a subsequent fabricated article. For example, the laser-cut panel can be included in a door, a window, a wall (e.g., wall partition), a skylight in a residential or commercial building, a vehicle (e.g., rearview mirror, sideview mirror, sun roof, moon roof), in other applications. In some examples, the laser-cut multilayer panel is incorporated into a larger structure, such as a privacy glazing structure.

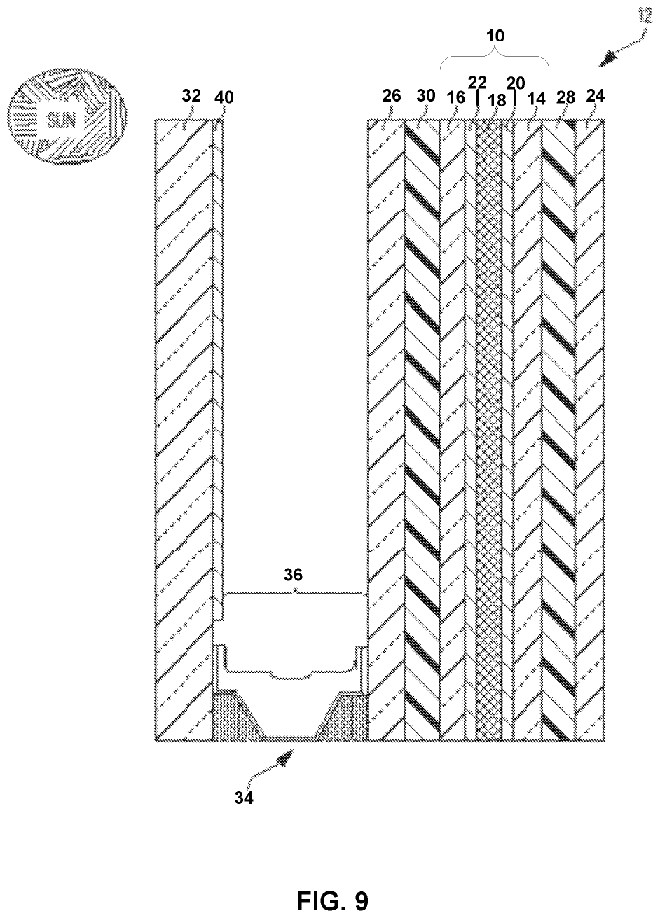

FIG. 9 is a side view of an example privacy glazing structure 12 that can incorporate a laser-cut multilayer panel according to the disclosure. In FIG. 9, privacy glazing structure 12 includes multilayer panel 10 laser cut along at least a portion of a length of at least one edge according to the techniques of the present disclosure. Multilayer panel 10 includes first substrate 14, second substrate 16, and a layer of optically active material 18 bounded between the two panes of transparent material. The privacy glazing structure 12 also includes a first electrode layer 20 and a second electrode layer 22. The first electrode layer 20 is carried by the first substrate of transparent material 14 while the second electrode layer 22 is carried by the second substrate of transparent material. In operation, electricity supplied through the first and second electrode layers 20, 22 can control the optically active material 18 to control visibility through the privacy glazing structure.

In some examples, including the example of FIG. 9, one or more panes of multilayer panel 10 can be implemented using laminated panes that include a laminate layer with an outer sandwiching pane. For example, in FIG. 9, privacy glazing structure 12 includes a third substrate of transparent material 24 and a fourth substrate of transparent material 26. A first laminate layer 28 bonds the first substrate of transparent material 14 to the third substrate of transparent material 24. A second laminate layer 30 bonds the second substrate of transparent material 16 to the fourth substrate of transparent material 26. In particular, the first substrate of transparent material 14 can define an inner face on the side of the substrate facing optically active material 18 and an outer face on an opposite side of the pane. Similarly, the second substrate of transparent material 16 can define an inner face on the side of the substrate facing optically active material 18 and an outer face on an opposite side of the pane. First laminate layer 28 may contact the outer face of the first substrate of transparent material 14, or a coating deposited thereover, and an opposed face of the third substrate of transparent material 24 to bond the two panes together. Second laminate layer 30 may contact the outer face of the second substrate of transparent material 16, or a coating deposited thereover, and an opposed face of the fourth substrate of transparent material 26 to bond the two panes together.

When one or more panes of multilayer panel 10 are implemented using laminated panes that include a laminate layer with an outer sandwiching pane, the entire thickness of the laminate pane (including substrate 14 and/or 16, laminate layer, and outer sandwiching pane) can be cut using the laser cutting techniques of the present disclosure. Alternatively, the laminate layer(s) and outer sandwiching pane(s) can be applied to one or both panes of multilayer panel 10 after laser cutting the multilayer panel using the laser cutting techniques of the present disclosure.

In some configurations, privacy glazing structure 12 is implemented as a privacy cell where the panes of the structure are joined together without intervening spacer to define a between-substrate space. In other configurations, however, including the configuration of FIG. 9, privacy glazing structure 12 includes a fifth substrate of material 32 spaced-apart from the privacy cell by a spacer 34 to define a between-substrate space 36. The addition of one or more between-substrate spaces, which may be filled with insulative gas, can be useful to increase the thermal performance of the privacy glazing structure. This can be beneficial for window, door, and skylight applications.

In some examples, privacy glazing structure 12 includes one or more functional coatings that enhance the performance, optical characteristics, and/or reliability of the privacy glazing structure. One type of functional coating that may be included on the privacy glazing structure is a low emissivity coating 40. In general, a low emissivity coating is a coating that is designed to allow near infrared and visible light to pass through a substrate while substantially preventing medium infrared and far infrared radiation from passing through the panes. A low-emissivity coating may include one or more layers of infrared-reflection film interposed between two or more layers of transparent dielectric film. The infrared-reflection film may include a conductive metal like silver, gold, or copper. The transparent dielectric film may include one or more metal oxides, such an oxide of zinc, tin, indium, bismuth, titanium, hafnium, zirconium, and alloys and combinations thereof and/or silicon nitride and/or silicon oxynitride. Advantageous low-emissivity coatings include the LoE-180™, LoE-272™, and LoE-366™ coatings available commercially from Cardinal CG Company of Spring Green, Wisconsin, U.S.A. Additional details on low emissivity coating structures that can be used for privacy glazing structure 12 can be found in U.S. Pat. No. 7,906,203, the entire contents of which are incorporated herein by reference.

In various examples, first laminate layer 28 and second laminate layer 30 may be formed of polyvinyl butyral (PVB), ethylene-vinyl acetate (EVA), thermoplastic polyurethane (TPU), an ionomer film such as SentryGlas® material available from DuPont®, or yet other suitable polymeric material. Each laminate layer may be formed of the same material, or the two laminate layers may be formed of different materials. In some configurations, first laminate layer 28 and/or second laminate layer 30 may have a thickness ranging from 0.005 inches (0.127 mm) to 0.25 inches (6.35 mm), such as from 0.01 inches (0.254 mm) to 0.1 inches (2.54 mm), or from 0.015 inches (0.381 mm) to 0.09 inches (2.286 mm).

In the example of FIG. 9, privacy glazing structure 12 includes a between-substrate space 36 formed by a spacer 34. Spacer 34 may extend around the entire perimeter of the multi-substrate privacy glazing structure to hermetically seal the between-substrate space 36 from gas exchange with a surrounding environment. To minimize thermal exchange across the structure, between-substrate space 36 can be filled with an insulative gas or even evacuated of gas. For example, between-substrate space 36 may be filled with an insulative gas such as argon, krypton, or xenon. In such applications, the insulative gas may be mixed with dry air to provide a desired ratio of air to insulative gas, such as 10 percent air and 90 percent insulative gas. In other examples, between-substrate space 36 may be evacuated so that the between-substrate space is at vacuum pressure relative to the pressure of an environment surrounding privacy glazing structure 12.

Spacer 34 can be any structure that holds opposed substrates in a spaced-apart relationship over the service life of privacy glazing structure 12 and seals between-substrate space 36 between the opposed panes of material, e.g., so as to inhibit or eliminate gas exchange between the between-substrate space and an environment surrounding the unit. One example of a spacer that can be used as spacer 34 is a tubular spacer positioned between fifth substrate of transparent material 32 and fourth substrate of transparent material 26. The tubular spacer may define a hollow lumen or tube which, in some examples, is filled with desiccant. The tubular spacer may have a first side surface adhered (by a first bead of sealant) to the surface of the fifth substrate of transparent material 32 and a second side surface adhered (by a second bead of sealant) to the fourth substrate of transparent material 26. A top surface of the tubular spacer can be exposed to between-substrate space 36 and, in some examples, includes openings that allow gas within the between-substrate space to communicate with desiccating material inside of the spacer. Such a spacer can be fabricated from aluminum, stainless steel, a thermoplastic, or any other suitable material. Advantageous glazing spacers are available commercially from Allmetal, Inc. of Itasca, IL, U.S.A.

To help facilitate installation of privacy glazing structure 12, the structure may include a frame or sash surrounding the exterior perimeter of the structure. In different examples, the frame or sash may be fabricated from wood, metal, or a plastic material such a vinyl. The frame or sash may define a channel that receives and holds the external perimeter edge of structure.

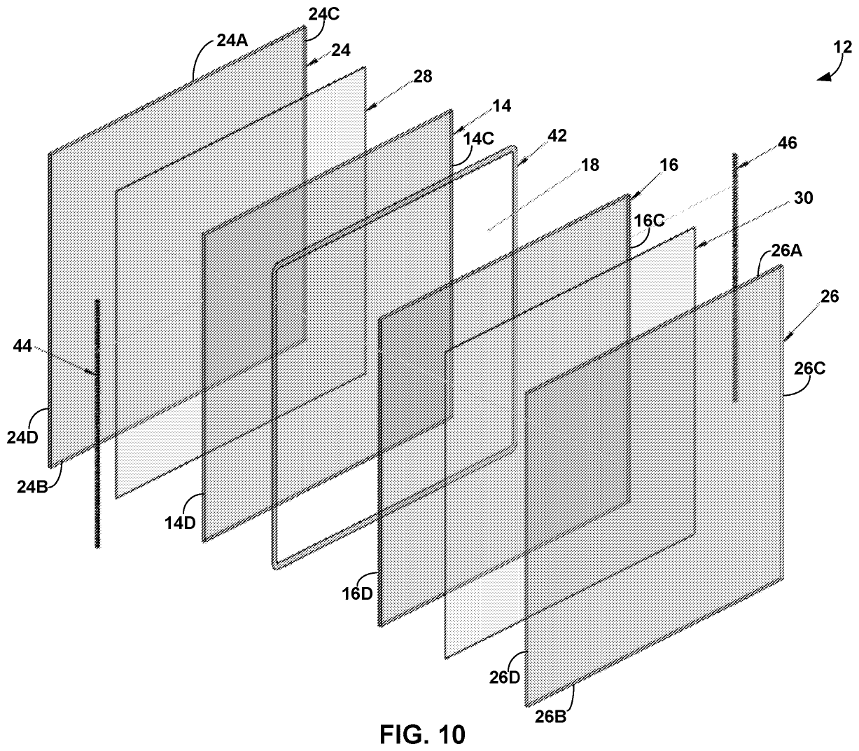

FIG. 10 is an exploded perspective view of an example configuration of privacy glazing structure 12, where like reference numerals refer to like elements discussed above. As shown in FIG. 10, privacy glazing structure 12 includes previously-described first substrate of transparent material 14, second substrate of transparent material 16, and optically active material 18. Privacy glazing structure 12 also includes third substrate of transparent material 24 bonded to first substrate of transparent material 14 by first laminate layer 28 and fourth substrate of transparent material 26 bonded to second substrate of transparent material 16 by second laminate layer 30. Privacy glazing structure 12 in FIG. 10 is also illustrated as having a seal 42 surrounding optically active material 18 and enclosing the optically active material between the first and second panes of transparent material. Seal 42 can joint first substrate 14 to second substrate 16. In addition, privacy glazing structure 12 includes at least one electrode for connecting first electrode layer 20 (FIG. 9) and second electrode layer 22 (FIG. 9) to a power source. In FIG. 10, the at least one electrode is illustrated as being implemented using two electrodes: a first electrode 44 and a second electrode 46.

Each substrate of privacy glazing structure 12 may have multiple edges that define the boundaries of the pane. For example, first substrate of transparent material 14 is illustrated as having a top edge, a bottom edge, a first side edge 14C, and a second side edge 14D. Second substrate of transparent material 16 is illustrated as having a top edge, a bottom edge, a first side edge 16C, and a second side edge 16D. Similarly, third substrate of transparent material 24 is illustrated as having a top edge 24A, a bottom edge 24B, a first side edge 24C, and a second side edge 24D. Finally, in FIG. 2, fourth substrate of transparent material 26 is illustrated as having a top edge 26A, a bottom edge 26B, a first side edge 26C, and a second side edge 26D. It should be appreciated that references to the top, bottom, and sides are relative positional references made with respect to gravity and the typical orientation of privacy glazing structure 12 in use, however, a structure according to the disclosure is not limited to any particular orientation.

In general, each substrate of transparent material in privacy glazing structure 12 can define any desired shape, including a polygonal shape (e.g., square, rectangular, hexagonal, trapezoid), an arcuate shape (e.g., circular, elliptical) shape, or combinations of polygonal and arcuate shapes (e.g., rectangle transitioning into a semi-circle). Typically, each substrate of transparent material in privacy glazing structure 12 will be of the same shape (e.g., square, rectangular) but may or may not have different sizes as discussed herein.

To bond and/or seal the first substrate of transparent material 14 to the second substrate of transparent material 16 with optically active material 18 between the two panes, seal 42 may be positioned between the two panes. The seal may be implemented using one or more polymeric sealants that are positioned to extend around the perimeter of the first substrate of transparent material 14 and the second substrate of transparent material 16, e.g., adjacent to and/or in contact with the peripheral edge surface of the panes. The sealant(s) may bond the first substrate of transparent material 14 to the second substrate of transparent material 16 about their perimeter, e.g., to prevent ingress or egress of liquid from the region bounded by the sealant(s). For example, the sealants may hold liquid optically active material 18 between the panes within the region bounded by the sealant(s) and/or inhibit external moisture from reaching the optically active material. Multiple seals 42 may be applied to different zones of mother sheet 144 (FIG. 8) during fabrication, when using mother sheet processing techniques.

As briefly mentioned above, the panes of transparent material forming privacy glazing structure 12, whether implemented alone as a cell or in the form of a multiple-substrate structure with a between-substrate space, can be arranged to provide electrical connection regions to facilitate making electrical connections with first electrode layer 20 and second electrode layer 22. In some examples, the positions of the panes are coordinated relative to each other to achieve robust yet compact electrical connections.

In one configuration, a side edge of the first substrate of transparent material 14 is recessed relative to a corresponding side edge of third substrate of transparent material 24. This can provide a first recess in which an electrode contact pad on second substrate of transparent material 16 is exposed for bonding first electrode 44. In addition, a side edge of the second substrate of transparent material 16 can be recessed relative to a corresponding side edge of fourth substrate of transparent material 26. This can provide a second recess in which an electrode contact pad on first substrate of transparent material 14 is exposed for bonding second electrode 46. In combination with configuring privacy glazing structure 12 with side recesses, the bottom edges of the first substrate of transparent material 14 and the second substrate of transparent material 16 may be flush with each other. In addition, the bottom edges of these panes may also be flush with the bottom edges of the third substrate of transparent material 24And the fourth substrate of transparent material 26. In this way, the edges of the panes bounding optically active material 18 may be asymmetrically positioned with respect to corresponding edges of the outer sandwiching or laminate panes.

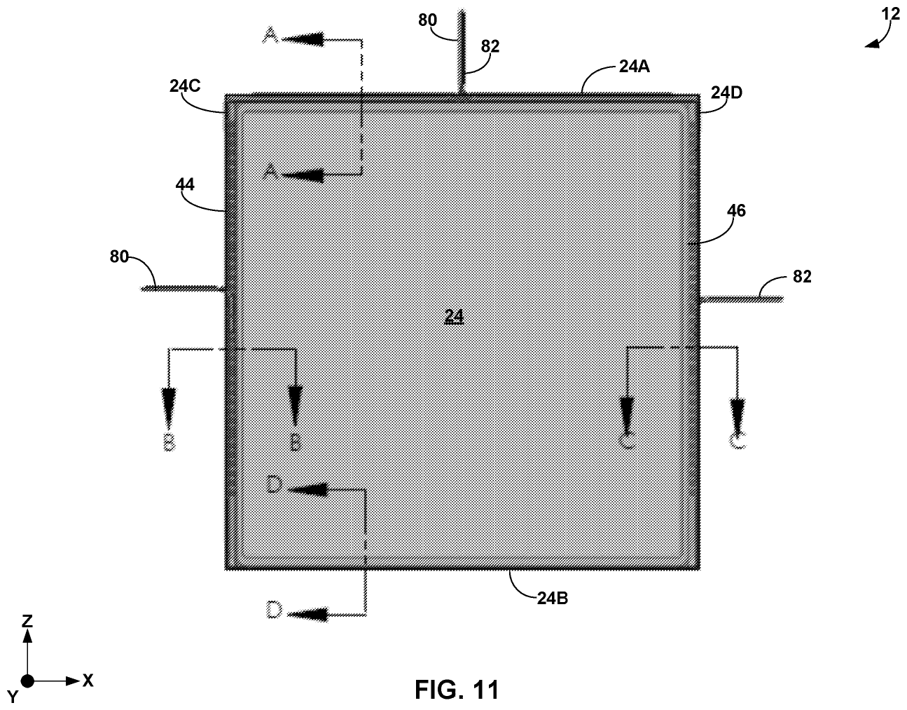

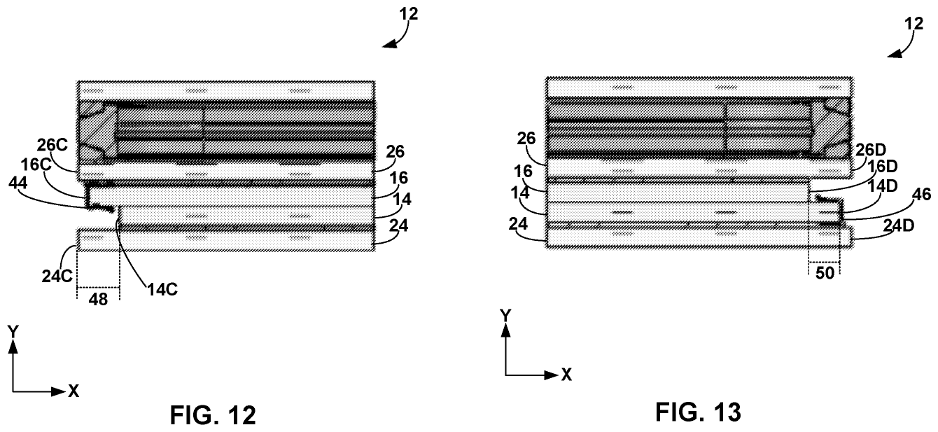

FIG. 11 is a side view of privacy glazing structure 12 from FIG. 9 from the perspective of fourth substrate of transparent material 26. FIG. 12 is a first side view of privacy glazing structure 12 taken along the B-B sectional line indicated on FIG. 11. FIG. 13 is a second side view of privacy glazing structure 12 taken along the C-C sectional line indicated on FIG. 11.

The depth that first substrate of transparent material 14 is recessed relative to third substrate of transparent material 24 on the first side and the depth that the second substrate of transparent material 16 is recessed relative to the fourth substrate of transparent material 26 on the second side may vary, for example, depending on the size and configuration of electrode to be attached to a corresponding exposed electrode layer. In some configurations, privacy glazing structure 12 defines a first side recess distance 48 (FIG. 12) and a second side recess distance 50 (FIG. 13) that is less than 12.5 mm, such as less than 10 mm, less than 9 mm, or less than 7 mm. For example, first side recess distance 48 and/or second side recess distance 50 may range from approximately 4 mm to approximately 8 mm, such as approximately 6 mm. In other examples, first side recess distance 48 and second side recess distance 50 may be less than approximately 4 mm, such as from 1 mm to 4 mm. Appropriately sizing first side recess distance 48 and second side recess distance 50 may provide sufficient real estate for bonding each electrode with an exposed electrode layer while minimizing the sight line impact of the recess. While first side recess distance 48 and second side recess distance 50 may be the same such that privacy glazing structure 12 is configured with symmetrical side recesses, in other configurations, the distances may be different (with first side recess distance 48 being greater than or less than second side recess distance 50). In either case, first side recess distance 48 and/or second side recess distance 50 can be created by laser cutting a portion of first substrate 14 and/or second substrate 16, respectively, to create a shelf on the opposed substrate having a size corresponding to the size of the

To establish an electrical connection between wiring entering into privacy glazing structure 12 from an external power source and each electrode layer, one or more electrodes may be provided. Each electrode may be bonded to one of the electrode layers 20, 22 and also connected to wiring. Accordingly, the electrode may form the terminal end of the wiring can be connected to the electrode layer.

In general, each electrode 44, 46 may be formed of an electrically conductive material (e.g., metal) and may have a cross-sectional area greater than that of the wire to which the electrode is attached. Each electrode 44, 46 can be implemented using any suitable electrode structure.

In one configuration, each electrode 44, 46 is formed by depositing a section of solder over a surface of a respective electrode layer. For example, each electrode 44, 46 may be formed by depositing a length of solder material via an ultrasonic deposition process on and/or over a respective electrode layer. As another example, electrodes 44, 46 may be implemented as a mechanical structure that wraps around the side edge of the respective substrate to which the electrode is electrically coupled to the electrode layer carried by the pane.

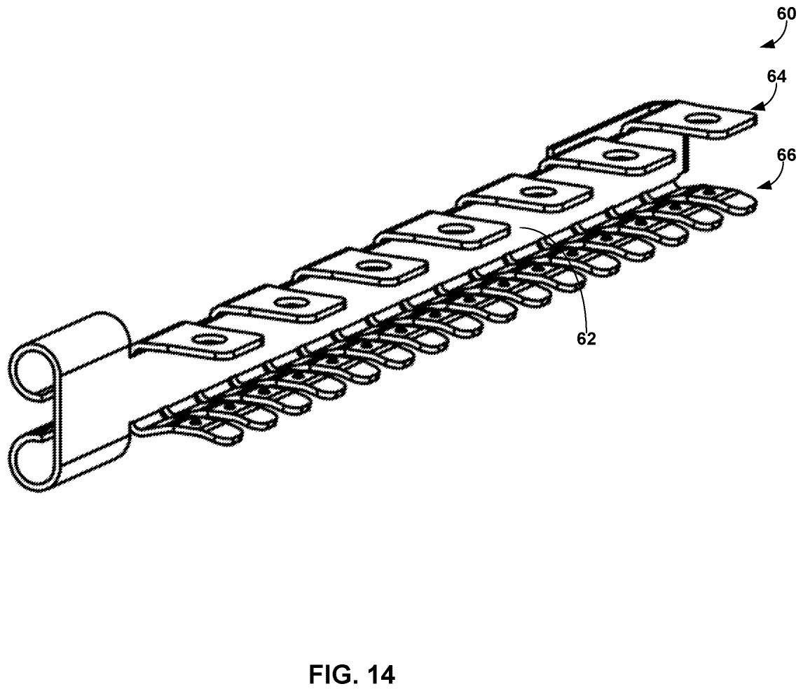

FIG. 14 is a perspective view of an example electrode 60 that may be used as electrodes 44 and/or 46 in privacy glazing structure 12 with a wraparound configuration. As shown in this example, electrode 60 has a base 62 from which a first leg 64 and a second leg 66 extend. The first and second leg 64, 66 are illustrated as extending generally perpendicularly from base 62 to define a U-shaped cross-section although may extend at different angles. In use, base 62 of electrode 60 may be positioned in contact with the side edge of the pane carrying the electrode layer to which the electrode is to be connected. First leg 64 may extend parallel to the outer face of the pane, and optionally in contact with the outer face. Second leg 66 may extend parallel to the inner face of the pane carrying the electrode layer.

To secure electrode 60 the pane, first leg 64 of electrode 60 may wrap around the side edge of the substrate to which the electrode is to be attached. In some examples, first leg 64 of electrode 60 is secured into a laminate layer to help retain the electrode to the pane. Second leg 66 of electrode 60 can physically contact the underlying electrode layer to which the electrode is bonded to establish an electrical pathway from the electrode layer to the electrode. Second leg 66 of electrode 60 may have a plurality of spaced apart fingers which are angled or biased, causing the fingers to press against the inner surface of the pane against which the fingers are positioned with a biasing force. This can help maintain the electrode in contact with the underlying electrode layer. In some examples, each finger of second leg 66 includes a tooth. The tooth may function to pierce an optional overcoat layer deposited over an electrode layer to which electrode 60 is attached, allowing the electrode to establish an electrical communication pathway through the overcoat layer.

Independent of the specific configuration of first electrode 44 and second electrode 46, the electrodes may each be attached to electrical wiring that extends from the respective electrode out of privacy glazing structure 12. The wiring can extend back to a power source (e.g., alternating current, directly current) and driver, which may condition the power received from the power source (e.g., control voltage, waveform, frequency).

It should be appreciated that the descriptive terms “top” and “bottom” and “underlying” and “overlying” with respect to the configuration and orientation of components described herein are used for purposes of illustration based on the orientation in the figures. The arrangement of components in real world application may vary depending on their orientation with respect to gravity. Accordingly, unless otherwise specified, the general terms “first” and “second” may be used interchangeably with the terms “top” and “bottom” and “underlying” and “overlying” without departing from the scope of disclosure.

Various examples have been described. These and other examples are within the scope of the following claims.

1. A method of laser cutting a multilayer glass panel, the method comprising:
directing a laser beam into a multilayer panel that comprises a first glass substrate joined to a second glass substrate, wherein directing the laser beam into the multilayer panel comprises forming a separation line comprising a plurality of spaced-apart defect columns extending at least partially through the first glass substrate but not through the second glass substrate, each of the plurality of spaced-apart defect columns comprising a plurality of spaced-apart filamentation flaws; and
separating a portion of the first glass substrate from the second glass substrate along the separation line to thereby configure the multilayer panel with a shelf defined by a portion of the second glass substrate extending outwardly from the separation line.

2. The method of claim 1, wherein each of the plurality of spaced-apart defect columns has a width within a range from 0.1 mm to 1.0 mm.

3. The method of claim 1, wherein a distance separating each of the plurality of spaced-apart defect columns from an adjacent one of the plurality of spaced-apart defect columns is within a range from 0.1 mm to 1.0 mm.

4. The method of claim 3, wherein the distance separating each of the plurality of spaced-apart defect columns from the adjacent one of the plurality of spaced-apart defect columns is substantially constant across a length of the separation line.

5. The method of claim 3, wherein the distance separating each of the plurality of spaced-apart defect columns from the adjacent one of the plurality of spaced-apart defect columns varies across a length of the separation line.

6. The method of claim 1, wherein:
the plurality of spaced-apart defect columns have a combined width along the length of the separation line;
the multilayer panel defines regions devoid of laser-induced defects between the plurality of spaced-apart defect columns, the regions devoid of laser-induced defects having a combined width along the length of the separation line; and
a ratio of the combined width of the regions devoid of laser-induced defects divided by the combined width of the plurality of spaced-apart defect columns is within a range from 5:1 to 1:5.

7. The method of claim 1, wherein:
each of the plurality of spaced-apart filamentation flaws has a width within a range from 0.0005 mm to 0.0025 mm; and
a distance separating each of the plurality of spaced-apart filamentation flaws from an adjacent one of the plurality of spaced-apart filamentation flaws is within a range from 0.001 mm to 0.01 mm.

8. The method of claim 1, wherein directing the laser beam into the multilayer panel comprises generating an induced absorption within the first glass substrate that produces each of the plurality of spaced-apart filamentation flaws.

9. The method of claim 1, wherein directing the laser beam into the multilayer panel comprises directing a pulsed laser beam at the multilayer panel.

10. The method of claim 1, wherein:
the first glass substrate has an inner face and an outer face;
the second glass substrate has an inner face and an outer face;
the inner face of the first glass substrate is joined to the inner face of the second glass substrate; and
directing the laser beam into the multilayer panel comprises directing the laser beam through the outer face of the first glass substrate toward the inner face of the second glass substrate.

11. The method of claim 1, wherein:
the first glass substrate has an inner face and an outer face;
the second glass substrate has an inner face and an outer face;
the inner face of the first glass substrate carries a first electrically conductive layer;
the inner face of the second glass substrate carries a second electrically conductive layer; and
an electrically controllable optically active material is positioned between the first electrically conductive layer and the second electrically conductive layer.

12. The method of claim 11, wherein forming the separation line comprising the plurality of spaced-apart defect columns extending at least partially through the first glass substrate but not through the second glass substrate comprises electrically deactivating regions of the second electrically conductive layer aligned with each of the plurality of spaced-apart defect columns while maintaining electrical conductivity of the second electrically conductive layer in regions between the plurality of spaced-apart defect columns.

13. The method of claim 12, further comprising, attaching an electrode to the shelf defined by the portion of the second glass substrate extending outwardly from the separation line.

14. The method of claim 11, wherein the multilayer panel comprises a sealant bounding the electrically controllable optically active material, the sealant joining the inner face of the first glass substrate to the inner face of the second glass substrate.

15. The method of claim 11, wherein the electrically controllable optically active material is a liquid crystal material.

16. The method of claim 1, wherein forming the separation line comprising the plurality of spaced-apart defect columns extending at least partially through the first glass substrate but not through the second glass substrate comprises forming the plurality of spaced-apart defect columns having a length extending through an entire thickness of the first glass substrate and to a depth less than 0.5 mm below the inner face of the second glass substrate.

17. The method of claim 1, further comprising, after directing the laser beam into the multilayer panel and forming the separation line comprising the plurality of spaced-apart defect columns, directing a second laser beam across the separation line to form a plurality of secondary spaced-apart filamentation flaws extending partially but not fully through a thickness of the first glass substrate.

18. The method of claim 17, wherein the first glass substrate has an inner face and an outer face, and the secondary spaced-apart filamentation flaws extend to a depth less than 0.8 mm above the inner face of the first glass substrate.

19. The method of claim 17, wherein:
directing the laser beam into the multilayer panel and forming the separation line comprising the plurality of spaced-apart defect columns comprises forming regions of the first glass substrate devoid of laser-induced defects between the plurality of spaced-apart defect columns; and
directing the second laser beam across the separation line to form the plurality of secondary spaced-apart filamentation flaws comprises forming the secondary spaced-apart filamentation flaws over both the spaced-apart defect columns and the regions of the first glass substrate devoid of laser-induced defects.

20. The method of claim 17, wherein a distance separating each of the plurality of secondary spaced-apart filamentation flaws from an adjacent one of the plurality of secondary spaced-apart filamentation flaws is less than 1.0 mm.

21. The method of claim 17, wherein the plurality of secondary spaced-apart filamentation flaws extend across an entire length of the separation line.

22. The method of claim 1, wherein directing the laser beam into the multilayer panel comprises directing the laser beam into the multilayer panel from a first thickness direction and on a first lengthwise or widthwise side of the multilayer panel, and further comprising:
directing the laser beam into the multilayer panel from a second thickness direction and on a second lengthwise or widthwise side of the multilayer panel, wherein directing the laser beam into the multilayer panel from the second thickness direction comprises forming a second separation line comprising a second plurality of spaced-apart defect columns extending at least partially through the second glass substrate but not through the first glass substrate, each of the second plurality of spaced-apart defect columns comprising a second plurality of spaced-apart filamentation flaws; and
separating a portion of the second glass substrate from the first glass substrate along the second separation line to thereby configure the multilayer panel with a second shelf defined by a portion of the first glass substrate extending outwardly from the second separation line.

23. The method of claim 1, wherein separating the portion of the first glass substrate from the second glass substrate along the separation line comprises applying a mechanically and/or thermally induced force to propagate a crack along the separation line through each of the plurality of spaced-apart defect columns.

24. An electrically controllable optically active structure, the structure comprising:
a first glass substrate having an inner face and an outer face;
a second glass substrate having an inner face and an outer face, the second glass substrate being joined to the first glass substrate with the inner face of the first glass substrate facing the inner face of the second glass substrate;
an electrically controllable optically active material positioned between the inner face of the first glass substrate and the inner face of the second glass substrate; and
a first electrically conductive layer carried by the inner face of the first glass substrate and a second electrically conductive layer carried by the inner face of the second glass substrate, and the first electrically conductive layer and the second electrically conductive layer being arranged to electrically control the electrically controllable optically active material;
wherein the first glass substrate, the second glass substrate, and the electrically controllable optically active material define a multilayer panel having a first side edge and a second side edge;
the first side edge defines a first shelf comprising a portion of the second glass substrate extending outwardly from a cut edge of the first glass substrate, the cut edge of the first glass substrate having a plurality of spaced-apart defect columns extending at least partially through the first glass substrate but not through the second glass substrate, each of the plurality of spaced-apart defect columns comprising a plurality of spaced-apart filamentation flaws; and
the second side edge defines a second shelf comprising a portion of the first glass substrate extending outwardly from a cut edge of the second glass substrate, the cut edge of the second glass substrate having a plurality of spaced-apart defect columns extending at least partially through the second glass substrate but not through the second glass substrate, each of the plurality of spaced-apart defect columns comprising a plurality of spaced-apart filamentation flaws.

25. The structure of claim 24, wherein:
the second electrically conductive layer extends over the first shelf, and the second electrically conductive layer is electrically deactivated under the plurality of spaced-apart defect columns on the cut edge of the first glass substrate but electrically conductive in regions between the plurality of spaced-apart defect columns; and
the first electrically conductive layer extends over the second shelf, and the first electrically conductive layer is electrically deactivated under the plurality of spaced-apart defect columns on the cut edge of the second glass substrate but electrically conductive in regions between the plurality of spaced-apart defect columns.

26. The structure of claim 25, further comprising:
a first electrode electrically connected to the second electrically conductive layer through regions of the second electrically conductive layer between the plurality of spaced-apart defect columns on the first shelf; and
a second electrode electrically connected to the first electrically conductive layer through regions of the first electrically conductive layer between the plurality of spaced-apart defect columns on the second.

27. The structure of claim 24, wherein:
each of the plurality of spaced-apart defect columns on the cut edge of the first glass substrate and on the cut edge of the second glass substrate each has a width within a range from 0.1 mm to 1.0 mm; and
a distance separating each of the plurality of spaced-apart defect columns from an adjacent one of the plurality of spaced-apart defect columns on the cut edge of the first glass substrate and on the cut edge of the second glass substrate is within a range from 0.1 mm to 1.0 mm.

28. The structure of claim 24, wherein:
the plurality of spaced-apart defect columns on the cut edge of one of the first glass substrate or the cut edge of the second glass substrate have a combined width;
regions devoid of laser-induced defects are defined on the cut edge of the one of the first glass substrate or the cut edge of the second glass substrate, the regions devoid of laser-induced defects having a combined width along; and
a ratio of the combined width of the regions devoid of laser-induced defects divided by the combined width of the plurality of spaced-apart defect columns is within a range from 5:1 to 1:5.

29. The structure of claim 24, wherein:
each of the plurality of spaced-apart filamentation flaws on the cut edge of the first glass substrate and on the cut edge of the second glass substrate has a width within a range from 0.0005 mm to 0.0025 mm; and
a distance separating each of the plurality of spaced-apart filamentation flaws on the cut edge of the first glass substrate and on the cut edge of the second glass substrate from an adjacent one of the plurality of spaced-apart filamentation flaws is within a range 0.001 mm to 0.01 mm.

30. The structure of claim 24, further comprising:
a third substrate of transparent material that is generally parallel to the first glass substrate and the second glass substrate; and
a spacer positioned between the first substrate of transparent material and the third substrate of transparent material to define a between-substrate space, the spacer sealing the between-substrate space from gas exchange with a surrounding environment and holding the first substrate of transparent material a separation distance from the third substrate of transparent material.

31. A method comprising:
directing a laser beam into a mother sheet that comprises a first glass substrate joined to a second glass substrate with a plurality of defined zones each comprising an electrically controllable optically active material between the first glass substrate and the second glass substrate, wherein directing the laser beam into the mother sheet comprises forming a separation line to separate at least one of the plurality of defined zones from an adjacent region of the mother sheet, and wherein forming the separation line comprises forming a plurality of spaced-apart defect columns extending at least partially through the first glass substrate but not through the second glass substrate, each of the plurality of spaced-apart defect columns comprising a plurality of spaced-apart filamentation flaws; and
separating one of the plurality of defined zones comprising the electrically controllable optically active material from the adjacent region of the mother sheet by at least separating a portion of the first glass substrate from the second glass substrate along the separation line to thereby configure the separated one of the plurality of defined zones with a shelf comprising by a portion of the second glass substrate extending outwardly from the separation line.
